(19) United States
(12) Patent Application Publication
(10) Pub. No.: US 2017/0330197 A1
(43) Pub. Date: Nov. 16, 2017

(54) METHODS AND SYSTEMS FOR MANAGING COMPLIANCE PLANS

(71) Applicant: MCS2, LLC, Dublin, OH (US)

(72) Inventors: John P. DiMaggio, Powell, OH (US); Edward N. Stone, Dublin, OH (US)

(21) Appl. No.: 15/330,967

(22) Filed: Feb. 25, 2016

Related U.S. Application Data
(60) Provisional application No. 62/120,972, filed on Feb. 26, 2015.

(51) Int. Cl. G06Q 30/00; G06Q 10/06; G06F 19/00

(52) U.S. Cl. CPC G06Q 30/018; G06Q 10/0635; G06F 19/327

(57) ABSTRACT

The subject matter described herein includes systems and methods for managing, generating, analyzing, evaluating, and updating client compliance plans. The systems and methods include providing a continuous assessment, implementation and monitoring of a prioritized regulatory compliance remediation program or plan. The systems and methods further include processing the recurring inputs based on host compliance requirement data and client compliance data.

### PRIORITY CLAIM

This application claims priority to U.S. Provisional Patent Application No. 62/120,972 filed on Feb. 26, 2015, and entitled “METHOD AND SYSTEM FOR MANAGING COMPLIANCE PLANS”. The entirety of the aforementioned application is incorporated by reference herein.

### TECHNICAL FIELD

This disclosure generally relates to methods and systems for managing compliance plans. In particular, the present invention relates to a method and system for generating and updating a compliance remediation plan based on processing recurring inputs from a host compliance database and a client compliance database.

### BACKGROUND

Managing compliance with recent healthcare laws and regulations has become an issue for those in the healthcare industry. The Health Insurance Portability and Accountability Act (HIPAA) law was enacted in 1996 and mandates the security and confidentiality of medical patient information and data. The Health Information Technology for Economic and Clinical Health (HITECH) Act was enacted in 2009 and set meaningful use of interoperable Electronic Health Record (EHR) adoption in the health care system as a critical national goal and incentivized EHR adoption.

These laws, and associated regulations promulgated therefrom, are administered by the Office for Civil Rights (OCR) and the Department of Health and Human Services, and apply to all entities covered by the HIPAA and HITECH regulations (Covered Entities) and their Business Associates who have access to protected health information of the Covered Entity. These organizations can include: hospitals, physician provider practices, pharmacies, long term care organizations, homecare, hospice, labs, diagnostic companies, collection agencies, contractors, cloud-based software providers. Entities subject to these laws and regulations are morally and legally obligated to comply with hundreds of complex regulations as well as embrace a continual stream of newly emerging or amended regulations. An entity's failure to comply with applicable laws and regulations can result in sanctions, fines, imprisonment and less of governmental funding for certain organizations participating in the Meaningful Use Incentive Programs.

Federal-funding requirements, and the steep financial penalties affiliated with non-compliance have made the need for comprehensive, recurring and remediated assessments even more critical. Since 2009, breach reporting requirements tied to Meaningful Use incentives have revealed more than 900 incidents compromising the personal information of about 30 million affected individuals. Computer hackers and other data thieves recognize the potential value of an individual's personal information contained in health-care related files, and are constantly searching for new, vulnerable personal data bearing targets.

Keeping current with complex and dynamic regulations intended to safeguard medical patient information is a time-intensive and often ambiguous undertaking for healthcare staff that may already be challenged with an onerous workload. The HIPAA Security Rule alone includes over 60 components that are measured against over 90 controls established by the National Institute of Standards and Technology (NIST), and these are often both difficult to understand and easily misinterpreted by organization personnel outside of the field. Failure to understand and implement applicable regulations can easily result in non-compliance and a potential breach of protected medical patient data.

Compliance failure can occur if: security and privacy assessments are not performed comprehensively, security and privacy assessments are not performed recurrently, corrective actions are not implemented, corrective actions are implemented incorrectly, required policies and processes are not adhered to consistently, the privacy and security laws are misinterpreted, and/or healthcare personnel are not kept abreast of the ever-changing federal and state laws and regulations governing the privacy and security of personally identifiable healthcare information. There remains a need for a service provided to healthcare clients (Covered Entities and Business Associates) that acts to minimize or eliminate these potential compliance failures relating to host governmental requirements (HIPAA and HITECH Privacy and Security laws and regulations).

### SUMMARY

The following presents a simplified summary of the disclosure in order to provide a basic understanding of some aspects of the disclosure. This summary is not an extensive of the disclosure. It is intended to neither identify key or critical elements of the disclosure nor delineate any scope of the particular aspects of the disclosure, or any scope of the claims. Its sole purpose is to present some concepts of the specification in a simplified form as a prelude to the more detailed description that is presented in this disclosure.

In accordance with an aspect, an access component accesses a set of first client data from a client database and a set of first host data from a host database, wherein the set of first client data represents a first set of information for compliance evaluation, and wherein the set of first host data represents a first set of compliance requirements. A first planning component is also included that generates a customized client compliance plan based on a set of client objectives and a first comparison of the set of first client data to the set of first host data, wherein the customized client compliance plan represents a first state of compliance of the first set of information with respect to the set of first compliance requirements and the set of client objectives.

A scoring component assigns a set of first compliancy scores to the set of first client data based on a second comparison of the customized compliance plan to the set of first host data. Also included is a first generation component that generates a client remediation plan based on the set of first compliancy scores and a comparison of the client compliance plan to the, wherein the client remediation plan comprises a set of first remediation information representing guidance to improve the set of first client compliancy scores. A second generation component generates an updated customized compliance plan or an updated client remediation plan based on a first update to the set of first client data or a second update to the set of first host data.

Also disclosed herein is a method comprising accessing, by a system comprising a processor, a set of first client data from a client database and a set of first host data from a host database, wherein the set of first client data represents a first set of information for compliance evaluation, and wherein the set of first host data represents a first set of compliance requirements. The method further includes generating, by the system, a customized client compliance plan based on a set of client objectives and a first comparison of the set of first client data to the set of first host data, wherein the customized client compliance plan represents a first state of compliance of the first set of information with respect to the set of first compliance requirements and the set of client objectives.

The method also includes assigning, by the system, a set of first compliancy scores to the set of first client data based on a second comparison of the customized compliance plan to the set of first host data. Furthermore, the method includes generating, by the system, a client remediation plan based on the set of first compliancy scores and a comparison of the client compliance plan to the, wherein the client remediation plan comprises a set of first remediation information representing guidance to improve the set of first client compliancy scores. The method also includes generating, by the system, an updated customized compliance plan or an updated client remediation plan based on a first update to the set of first client data or a second update to the set of first host data.

The following description and the annexed drawings set forth in detail certain illustrative aspects of this disclosure. These aspects are indicative, however, of but a few of the various ways in which the principles of this disclosure may be employed. This disclosure intended to include all such aspects and their equivalents. Other advantages and distinctive features of this disclosure will become apparent from the following detailed description of this disclosure when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1A illustrates a high-level block diagram of an example system configured to manage client compliance plans in accordance with the subject application;

FIG. 1B illustrates a high-level block diagram of an example system configured to manage client compliance plans according to another embodiment in accordance with the subject application;

FIG. 1C illustrates a high-level block diagram of an example system configured to manage client compliance plans according to another embodiment in accordance with the subject application;

FIG. 1D illustrates a high-level block diagram of an example system configured to manage client compliance plans according to another embodiment in accordance with the subject application;

FIG. 1E illustrates a high-level block diagram of an example system configured to manage client compliance plans according to another embodiment in accordance with the subject application;

FIG. 1F illustrates a high-level block diagram of an example system configured to manage client compliance plans according to another embodiment in accordance with the subject application;

FIG. 1G illustrates a high-level block diagram of an example system configured to manage client compliance plans according to another embodiment in accordance with the subject application;

FIG. 2 illustrates a non-limiting embodiment of a method and system for managing compliance according to another embodiment in accordance with the subject application;

FIG. 3 illustrates a non-limiting embodiment of a reoccurring process and inputs of the systems and methods illustrated in FIG. 2 in accordance with the subject application;

FIG. 5 illustrates a non-limiting embodiment of four categories of inputs for a client compliance database illustrated in FIG. 2 in accordance with the subject application;

FIG. 6 illustrates a non-limiting embodiment of a technical client data flow category illustrated in FIG. 4 in accordance with the subject application;

FIG. 7 illustrates a non-limiting embodiment of a physical client data flow category illustrated in FIG. 4 in accordance with the subject application;

FIG. 8 illustrates a non-limiting embodiment of a process client data flow category illustrated in FIG. 4 in accordance with the subject application;

FIG. 9 illustrates a non-limiting embodiment of a method and system of FIG. 2 in accordance with the subject application;

FIG. 10 illustrates a non-limiting embodiment of a client portal of FIG. 2 in accordance with the subject application;

FIG. 11 illustrates a non-limiting diagram of an input and output component of a provider processor of FIG. 2 in accordance with the subject application;

FIG. 12 illustrates a non-limiting example of a method for managing compliance plans in accordance with the subject application;

FIG. 13 illustrates a non-limiting example of a method for managing compliance plans in accordance with the subject application;

FIG. 14 illustrates a non-limiting example of a method for managing compliance plans in accordance with the subject application;

FIG. 15 illustrates a non-limiting example of a method for managing compliance plans in accordance with the subject application;

FIG. 16 is a schematic block diagram illustrating a suitable operating environment in accordance with various aspects and embodiments;

FIG. 17 is a schematic block diagram of a sample-computing environment in accordance with various aspects and embodiments.

### DETAILED DESCRIPTION

The innovation is described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

By way of introduction, the subject disclosure is related to systems, methods, and interfaces for managing compliance plans. In one or more embodiments, a system can include a computer-readable storage media having stored thereon computer executable components, and a processor configured to execute computer executable components stored in the computer-readable storage media. These components can include an access component configured to access a set of first client data from a client database and a set of first host data from a host database, wherein the set of first client data represents a first set of information for compliance evaluation, and wherein the set of first host data represents a first set of compliance requirements. The system can further include a first planning component configured to generate a customized client compliance plan based on a set of client objectives and a first comparison of the set of first client data to the set of first host data, wherein the customized client compliance plan represents a first state of compliance of the first set of information with respect to the set of first compliance requirements and the set of client objectives.

Furthermore, the system can include a scoring component configured to assign a set of first compliancy scores to the set of first client data based on a second comparison of the customized compliance plan to the set of first host data. Also, the system can include a first generation component configured to generate a client remediation plan based on the set of first compliancy scores and the second comparison, wherein the client remediation plan comprises a set of first remediation information representing guidance to improve the set of first client compliancy scores. Furthermore, the system can include a second generation component configured to generate an updated customized compliance plan or an updated client remediation plan based on a first update to the set of first client data or a second update to the set of first host data.

The above-outlined embodiments are now described in more detail with reference to the drawings, wherein like reference numerals are used to refer to like elements throughout. In the following description, for purposes of explanation, numerous specific details are set forth in order to provide a thorough understanding of the embodiments. It may be evident, however, that the embodiments can be practiced without these specific details. In other instances, well-known structures and devices are shown in block diagram form in order to facilitate describing the embodiments.

In implementations, the components described herein can perform actions, in real-time, near real-time, online and/or offline. Online/offline can refer to states identifying connectivity between one or more components. In general, “online” indicates a state of connectivity, while “offline” indicates a disconnected state. In an aspect, offline merging can prevent service interruptions, end-user quality degradation, and the like.

While the various components are illustrated as separate components, it is noted that the various components can be comprised of one or more other components. Further, it is noted that the embodiments can comprise additional components not shown for sake of brevity. Additionally, various aspects described herein may be performed by one device or two or more devices in communication with each other. It is noted that while media items are referred to herein, the systems and methods of this disclosure can utilize other content items.

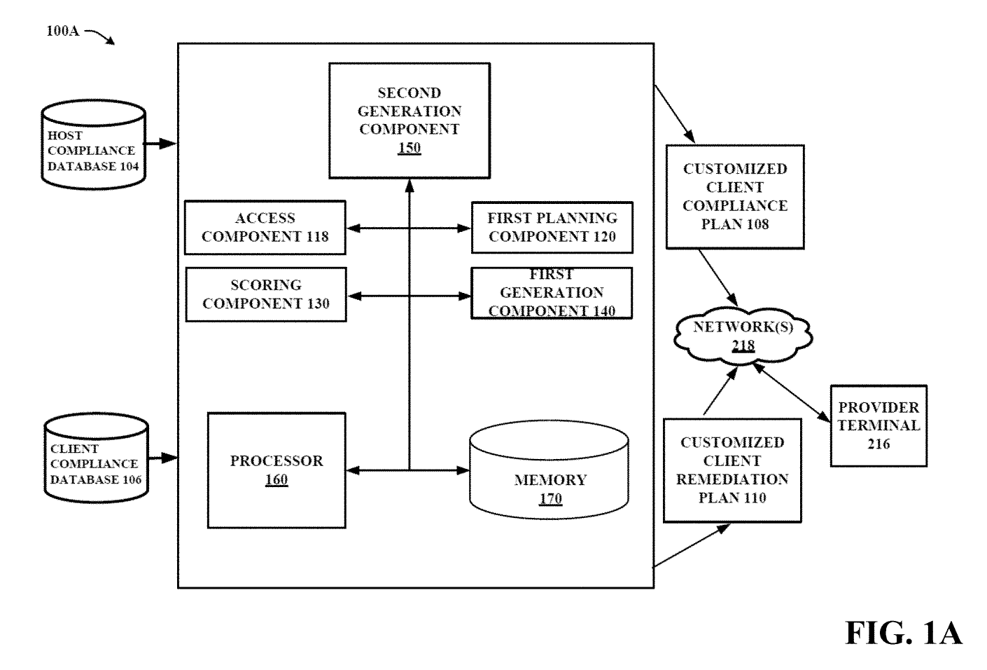

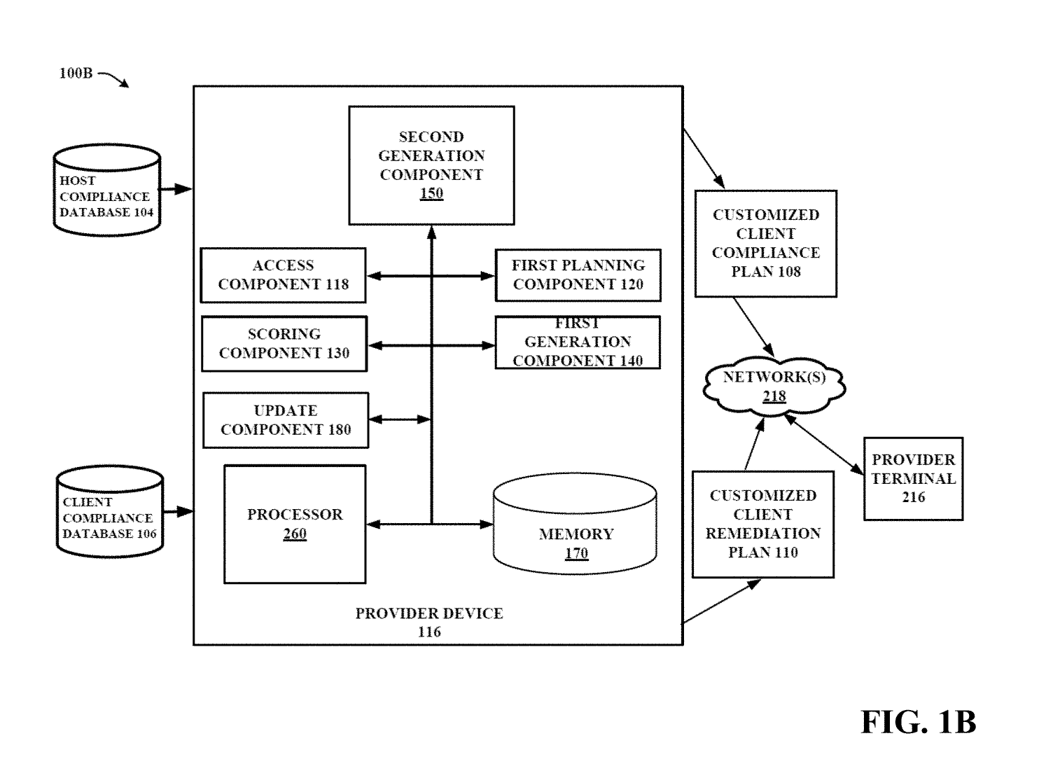

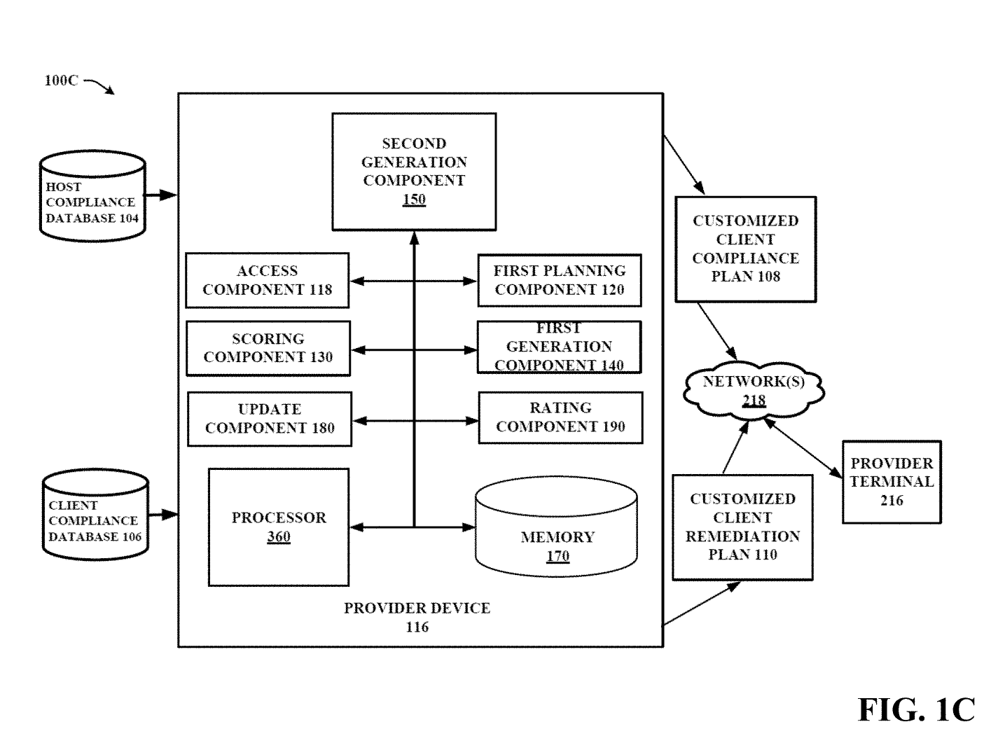

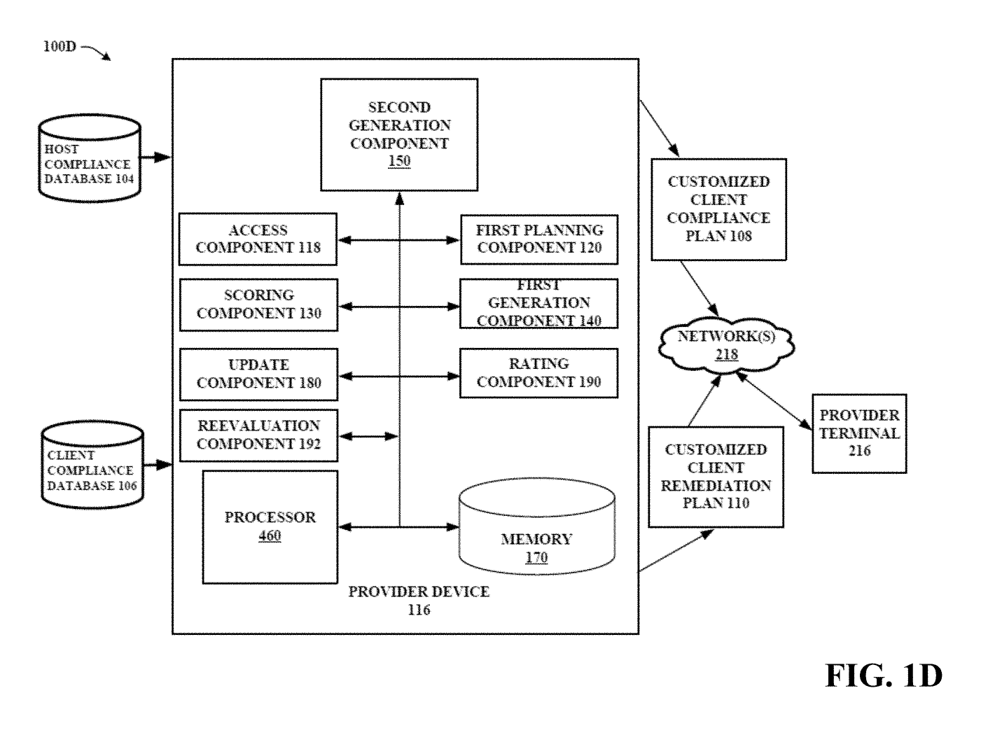

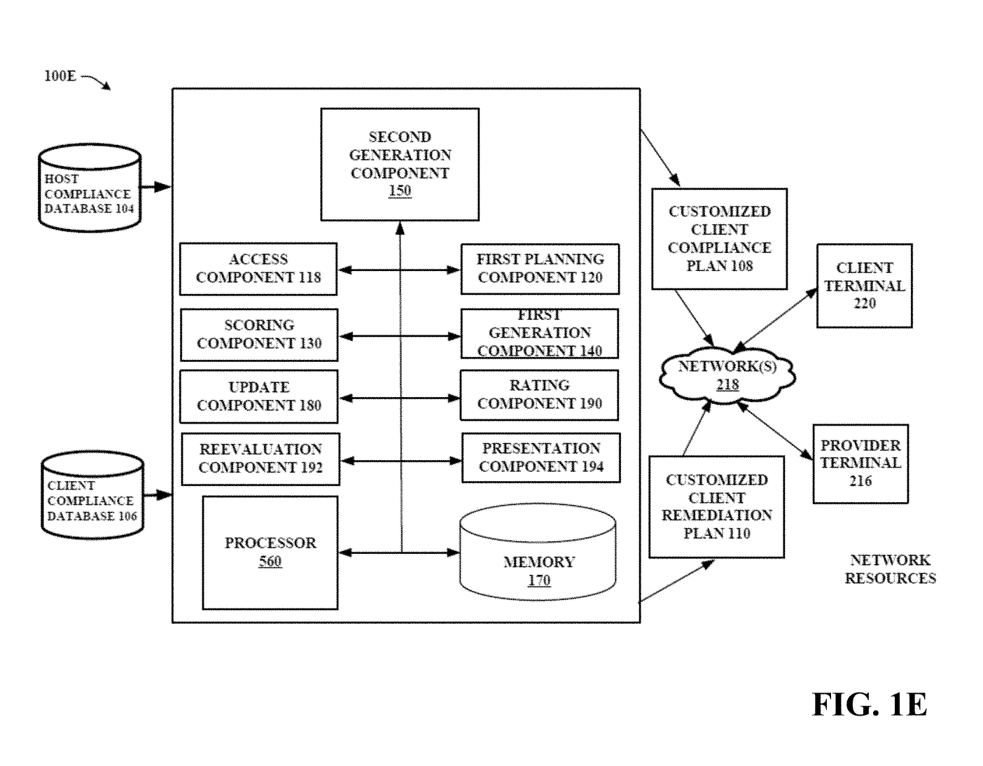

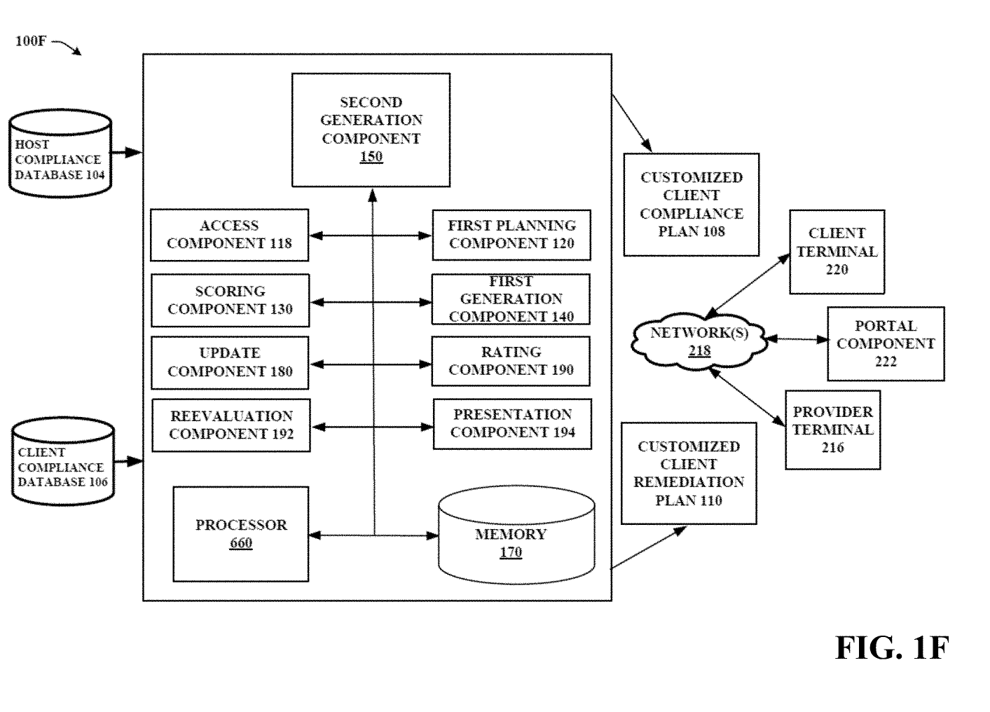

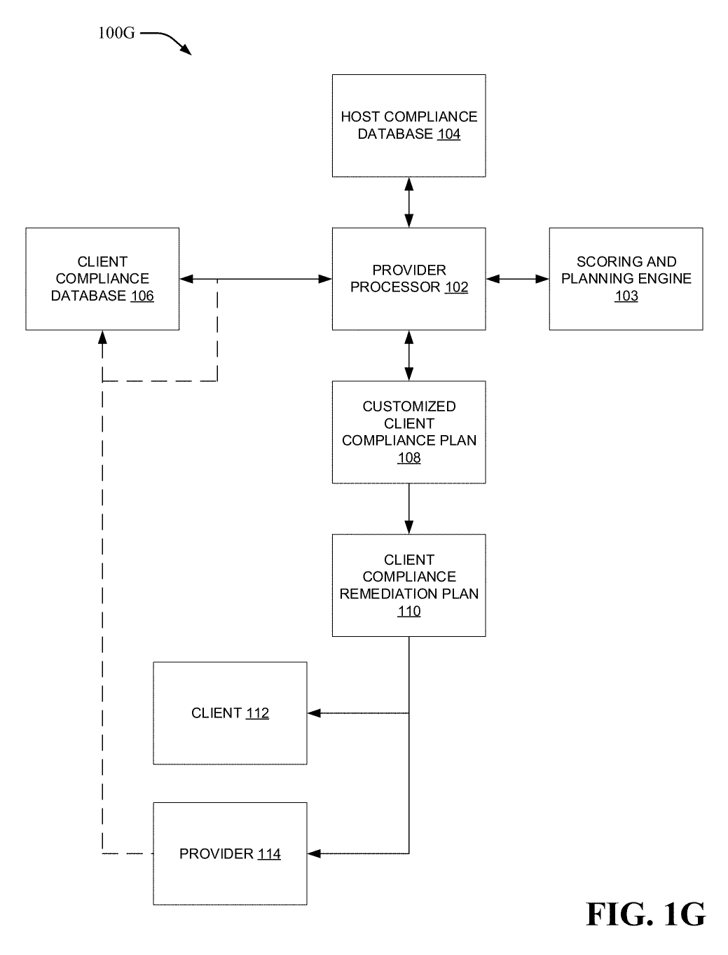

Referring now to FIG. 1A, presented is an example system 100A configured to manage compliance plans. The various components of system 100 and other systems described herein can be connected either directly or indirectly via one or more networks 118. In an aspect, system 100 includes a network 118 that can include wired and wireless networks, including but not limited to, a cellular network, a wide area network (WAN, e.g., the Internet), a local area network (LAN), or a personal area network (PAN). For example, provider 102 can communicate with a network resource 116 (and vice versa) using virtually any desired wired or wireless technology, including, for example, cellular, WAN, wireless fidelity (Wi-Fi), Wi-Max, WLAN, and etc. In an aspect, one or more components of system 100 are configured to interact via disparate networks. In an aspect, a provider component (e.g., computer device, server device, etc.) of system 100 can include a processor 102 (also referred to as provider processor 102) and can also include memory 114 that stores computer executable components, and a provider processor 102 executes the computer executable components stored in the memory 170. For example, one or more of the components employed by provider component can be stored in memory 170.

Furthermore, system 100A employs a memory 170 that stores executable components; and a processor 102, communicatively coupled to the memory 170, the provider processor 102 configured to facilitate execution of the executable components, the executable components comprising: an access component 118 configured to access a set of first client data from a client database 106 (also referred to as client compliance database 106) and a set of first host data from a host database 104 (also referred to as host compliance database 104), wherein the set of first client data represents a first set of information for compliance evaluation, and wherein the set of first host data represents a first set of compliance requirements.

In another aspect, system 100A employs a first planning component 120 configured to generate a customized client compliance plan 108 (also referred to as a customized client compliance plan 108) based on a set of client objectives and a first comparison of the set of first client data to the set of first host data, wherein the customized client compliance plan 108 represents a first state of compliance of the first set of information with respect to the set of first compliance requirements and the set of client objectives. In yet another aspect, a scoring component 130 is disclosed (also referred to as a scoring and planning engine 103) configured to assign a set of first compliancy scores to the set of first client data based on a second comparison of the customized client compliance plan 108 to the set of first host data.

System 100A also employs a first generation component 140 configured to generate a client remediation plan 110 (also referred to as a customized client remediation plan 110) based on the set of first compliancy scores and the second comparison, wherein the client remediation plan 110 comprises a set of first remediation information representing guidance to improve the set of first client compliancy scores. Furthermore, in an aspect, system 100A employs a second generation component 150 configured to generate an updated customized client compliance plan or an updated client remediation plan 110 based on a first update to the set of first client data or a second update to the set of first host data. System 100A also includes client terminal 220 and provider terminal 216.

In an aspect, a first subset of first client data of the set of first client data represents client compliance items required to satisfy a set of first compliance criteria and a second subset of first client data of the set of first client data represent a set of organization specific parameters. In another aspect, the first set of host data comprises federal regulatory requirement data, state regulatory requirement data, best practice compliance data, industry focused requirement data, control rule data, privacy compliance requirement data, or security compliance regulatory data comprising any one or more of International Organization for Standardization requirement data, Payment Card Industry requirement data, or Joint Commission on Accreditation of Healthcare Organizations requirement data.

Also, in an aspect, the set of first client data comprise policy data, process flow data, procedural data, technical flow data, environmental structure data, administrative flow data, technical flow data, physical flow data, process flow of data or organizational data, and wherein a first compliance score, a second compliance score, a third compliance score, and a fourth compliance score of the set of compliancy scores correspond to the administrative flow, the technical flow, the physical flow data, and the process flow data respectively. In yet another aspect, the first state of compliance comprises a set of deficient compliant items or a set of missing compliance items that fail to satisfy the first set of compliance requirements.

Turning now to FIG. 1B, there is illustrated a non-limiting implementation of a system 100B in accordance with various aspects and implementations of this disclosure. The system 100B includes the access component 118, first planning component 120, scoring component 130, first generation component 140, second generation component 150, processor 160, memory 170, customized client compliance plan 108, customized client remediation plan 110, network 118, client terminal 220, provider terminal 216, host compliance database 104, and client compliance database 106, client terminal 220 and provider terminal 216. In an aspect, system 100B can further employ an update component 180 that adds a set of second client data to the client compliance database 106, adds a set of second host data to the host compliance database 104, removes a second subset of first client data from the client compliance database 106, or removes a first subset of first host data from the host compliance database 104.

Furthermore, in an aspect, an addition of the set of second client data or a removal of a second subset of client data is based on the first update, the updated customized client compliance plan, the updated client remediation plan, a satisfaction of the first set of compliance requirements, a creation of new client goals or new client objectives in accordance with the set of second host data. Also, in an aspect, an addition of the set of second host data or a removal of the first subset of first host data is based on the second update to the set of first host data, the updated customized client compliance plan, the updated client remediation plan, an update to healthcare laws, an update to healthcare regulations, an update to privacy compliancy rules, an update to security compliancy rules.

Turning now to FIG. 1C, there is illustrated a non-limiting implementation of a system 100C in accordance with various aspects and implementations of this disclosure. The system 100C includes the access component 118, first planning component 120, scoring component 130, first generation component 140, second generation component 150, update component 180, processor 160, memory 170, customized client compliance plan 108, customized client remediation plan 110, network 118, client terminal 220, provider terminal 216, host compliance database 104, and client compliance database 106, client terminal 220 and provider terminal 216.

In an aspect, system 100C can further employ a rating component 190 that assigns a rating to a first compliancy score of the set of first compliancy scores, wherein the rating comprises a compliant rating based on whether the the first compliancy score falls within a first score range, a non-compliant rating based on whether the first compliancy score falls within a second score range, a needs improvement rating based on whether the first compliancy score falls within a third score range, a capability maturity rating that represents a client's compliance maturity based on whether the first compliancy score falls within a fourth score range in accordance with a capability maturity model, a cyber security rating based on whether the first compliancy score falls within a fifth score range in accordance with a cyber security framework.

In an aspect, the set of first remediation information comprises a list of required items to achieve the compliant rating, wherein an item of the list of items corresponds to a priority level. In another aspect, the set of second host data comprises updated federal regulatory requirement data, updated state regulatory requirement data, updated best practice compliance data, or updated industry focused requirement data, and wherein the set of second client data comprises new client data previously absent from the set of first client data for compliance evaluation or a rescored subset of first client data of the set of first client data based on a client implementation activity associated with the client remediation plan 110.

Turning now to FIG. 1D, there is illustrated a non-limiting implementation of a system 100D in accordance with various aspects and implementations of this disclosure. The system 100E includes the access component 118, first planning component 120, scoring component 130, first generation component 140, second generation component 150, update component 180, rating component 190, processor 160, memory 170, customized client compliance plan 108, customized client remediation plan 110, network 118, client terminal 220, provider terminal 216, host compliance database 104, and client compliance database 106, client terminal 220 and provider terminal 216. In an aspect, system 100D can further employ a reevaluation component 192 that performs a reoccurring comparison of a current set of host data within the host database and a current set of client data within the client database at a reoccurring time interval.

Turning now to FIG. 1E, there is illustrated a non-limiting implementation of a system 100E in accordance with various aspects and implementations of this disclosure. The system 100E includes the access component 118, first planning component 120, scoring component 130, first generation component 140, second generation component 150, update component 180, rating component 190, reevaluation component 192, processor 160, memory 170, customized client compliance plan 108, customized client remediation plan 110, network 118, client terminal 220, provider terminal 216, host compliance database 104, and client compliance database 106, client terminal 220 and provider terminal 216. In an aspect, system 100E can further employ a reevaluation component 192 that performs a reoccurring comparison of a current set of host data within the host database and a current set of client data within the client database at a reoccurring time interval.

In an aspect, system 100E can further employ a presentation component 194 that facilitates access by a provider device (e.g., provider terminal 216) or a client device (e.g., client terminal 220) to an assessment output associated with the first state of compliance, wherein the assessment output comprises at least one of a snapshot summary of the first state of compliance, an online active plan, an online active assessment corresponding to the client compliance plan, a risk profile corresponding to the first state of compliance, a peer report, a set of regulation scores associated with the set of first client data, a set of control scores associated with the set of first client data, the client compliance remediation plan, a timeline schedule associated with the client compliance remediation plan, a gap report comprising missing compliance items, a current recommendation report, an observation and risk assessment result report, an executive summary, an environment study.

Turning now to FIG. 1F, there is illustrated a non-limiting implementation of a system 100F in accordance with various aspects and implementations of this disclosure. The system 100F includes the access component 118, first planning component 120, scoring component 130, first generation component 140, second generation component 150, update component 180, rating component 190, reevaluation component 192, presentation component 194, processor 160, memory 170, customized client compliance plan 108, customized client remediation plan 110, network 118, client terminal 220, provider terminal 216, host compliance database 104, and client compliance database 106, client terminal 220 and provider terminal 216. In an aspect, system 100F can further employ a reevaluation component 192 that performs a reoccurring comparison of a current set of host data within the host database and a current set of client data within the client database at a reoccurring time interval.

In an aspect, system 100F can further employ a portal component 222 (also referred to as client portal 222) that facilitates management of the client remediation plan 110 and facilitates an interactive analysis of client data at an interface corresponding to a client device 220, wherein the interface comprises a client dashboard, a prioritized client task list, a client timeline, a client task reminder alert, a provider task list, a document library, or a meeting agenda and note application, and wherein the interface presents continuous correspondence of a subsequent state of compliance as compared to the first state of compliance, an analysis component that facilitates an application of analytics to client data or host data, or a recommendation component that provides a recommendations based on analyzed client data.

Turning now to FIG. 1G, illustrated is non-limiting flow diagram illustrating a general arrangement of a method and system 100G for managing compliance plans is shown in FIG. 1G according to an embodiment of the present invention. Method and system 100G includes a provider processor 102 programmed with a custom computer program to manage one or more client compliance plans. The custom computer program includes a scoring and planning engine 103 (also referred to as scoring component 130 and first planning component 120 respectively). The provider processor 102 is in communication with a host compliance database 104 and a client compliance database 106. The host compliance database 104 is created and updated (e.g., using update component 180) with host data relating to governmental compliance requirements.

As a non-limiting example, this host data may include data relating to healthcare laws, regulations and controls, such as HIPAA and HITECH Privacy and Security compliancy. The client compliance database 106 is created and updated with client data relating to the compliance plan in use by client and their goals in meeting governmental compliance requirements. As a non-limiting example, this client data may include data relating to compliance with healthcare laws and regulations, such as HIPAA and HITECH Privacy and Security compliancy, and is further detailed below.

The provider processor 102 utilizes inputs from the host compliance database 104 and the client compliance database 106 to compare the data inputs and create a customized client compliance plan 108 (e.g., using first planning component 120). The customized client compliance plan 108 may include client compliance items required to comply with the given governmental requirements based on the client's objectives. Utilizing the scoring (e.g., using coring component 130) and planning engine 103 (e.g., using first planning component 120), the provider processor 102 analyzes and compares the client compliance plan 108 to the client compliance database 106 and identifies missing and/or deficient items needed for compliance. The provider processor 102 utilizes these missing and/or deficient items to generate (e.g., using first generation component 140) a prioritized task list to guide the client in remediation. The prioritized task list is included as part of a client compliance remediation plan 110 as an output.

Referring again to FIG. 1G, the client compliance remediation plan 110 is available to the corresponding client 112 and to the service provider 114. The corresponding client 112 and the service provider 114 may make recurring (e.g., using reevaluation component 192) and/or continuous updates (e.g., using update component 180) to the client compliance database 106 based on the ongoing implementation of the client compliance remediation plan 110. Furthermore, the host compliance database 104 receives reoccurring (e.g., using reevaluation component 192) and/or continuous updates (e.g., using update component 180) of host compliance data. These host compliance data updates may be facilitated through the service provider 114 and/or through other sources. Thus, due to the recurring and/or continuous updates, the provider processor 102 may continue to update (e.g. using update component 180) the client compliance plan 108 and the client compliance remediation plan 110.

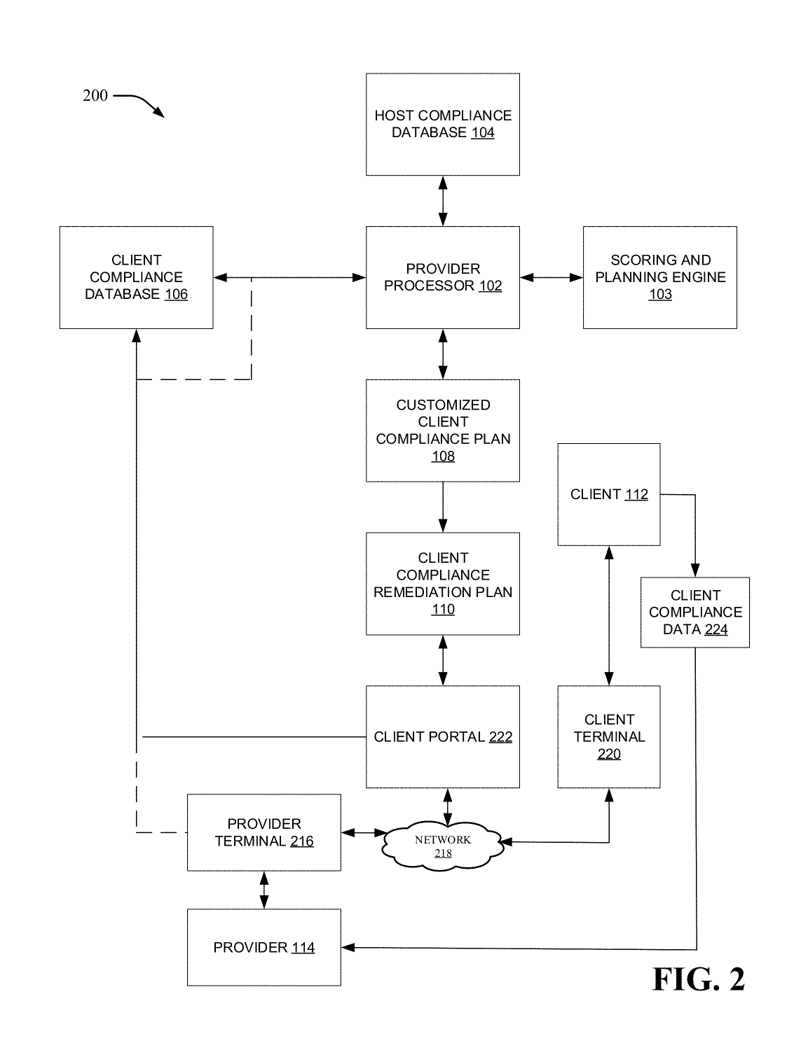

Turning now to FIG. 2, illustrated is a flow diagram showing a non-limiting general arrangement of a method and system 200 for managing compliance plans in accordance with another non-limiting embodiment of the present invention. Method and system 200 include the above elements of method and system 100G, and further includes a provider terminal 216, network 218, client terminal 220 and client portal 222. As a non-limiting example, provider terminal 216 and client terminal 220 may be personal computers or other computing input/output devices configured to communicate with network 218. Client compliance remediation plan 110 and client compliance database 106 may be accessible through the client portal 222. Client 112 may utilize client terminal 220 to access client portal 222 through network 218, and provider 114 may utilize provider terminal 216 to access client portal 222 through network 218. Client compliance data 224 may be entered through client terminal 220 or provider terminal 216.

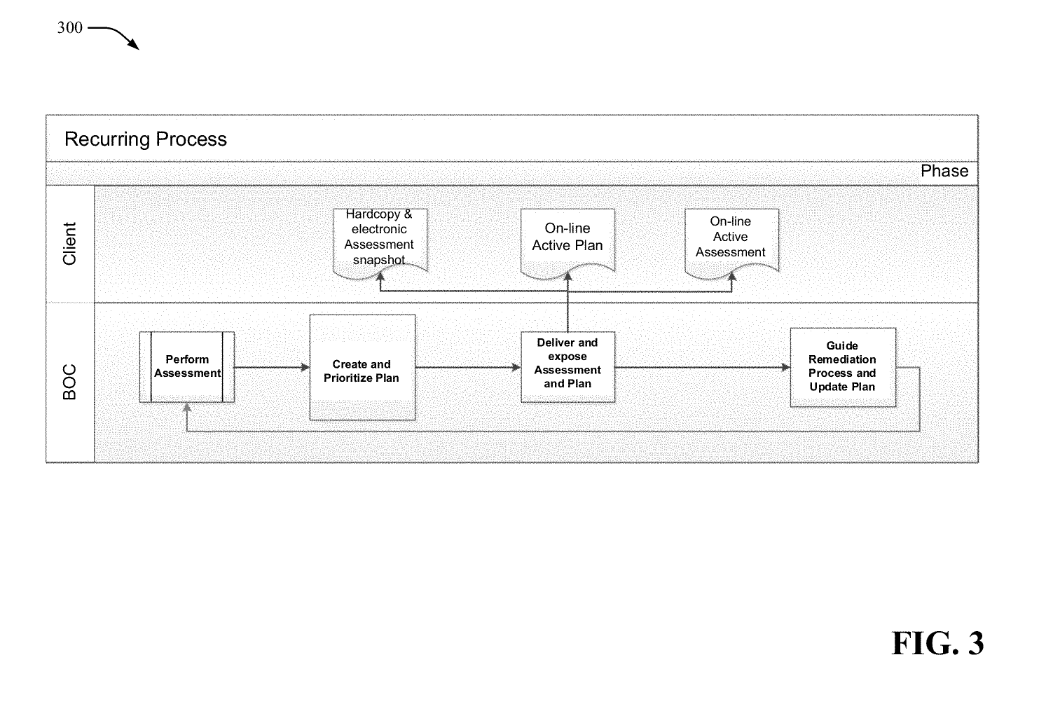

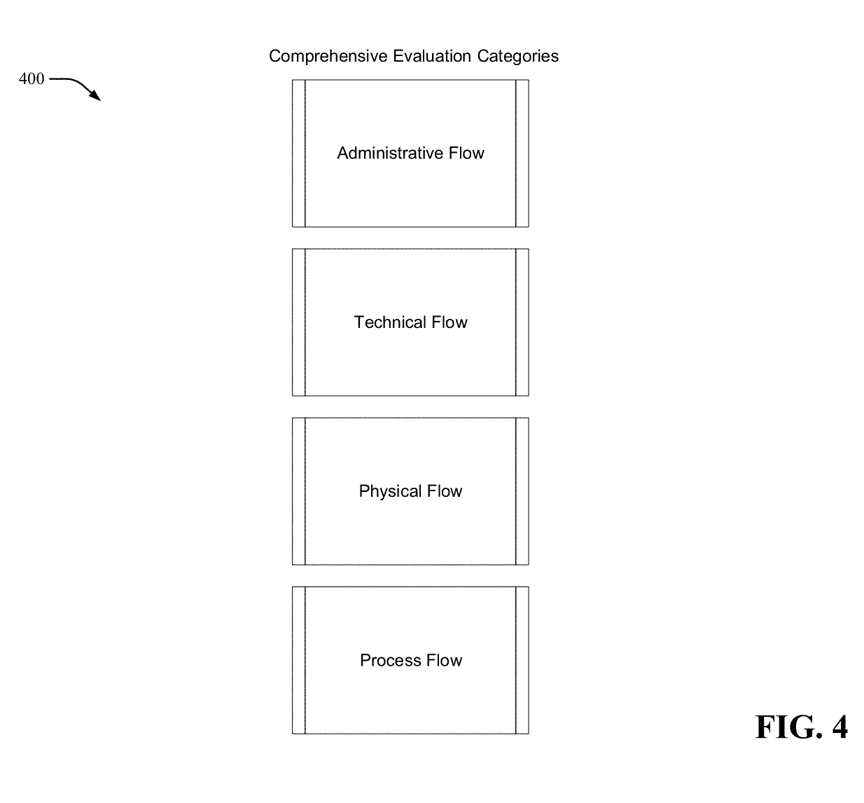

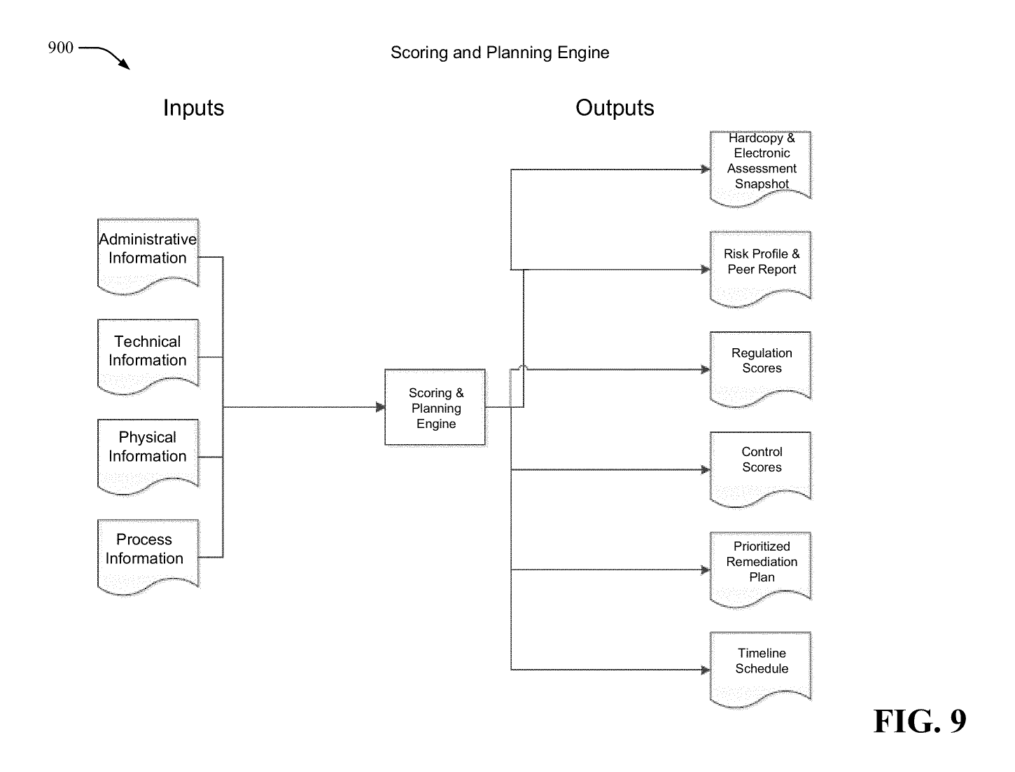

A flow diagram showing further details of the method and system 200 for managing compliance plans is shown in FIG. 3. The flow diagram further details the services provided by the provider and the outputs available to the client relating to the creation and management of the client compliance remediation plan 110, and these items are further explained below regarding FIG. 9. The provider portion illustrates the continuous and recurring assessment (e.g., using reevaluation component 192) and remediation of the method. The provider 114 may utilize processor 102 to perform the assessment of client compliance data 224 and to create and prioritize client compliance remediation plan 110. Provider 114 delivers or makes available and exposes the assessment and the client compliance remediation plan 110 to the client 112. The client 112 may receive an assessment snapshot, online active plan and online active assessment as part of the client compliance remediation plan 110. Provider 114 continues to guide client 112 in the remediation process and in updating the client compliance remediation plan 110. This iterative process involves provider 114 updating the client compliance database 106 during remediation with new client compliance data 224 to allow re-assessment by provider processor 102.

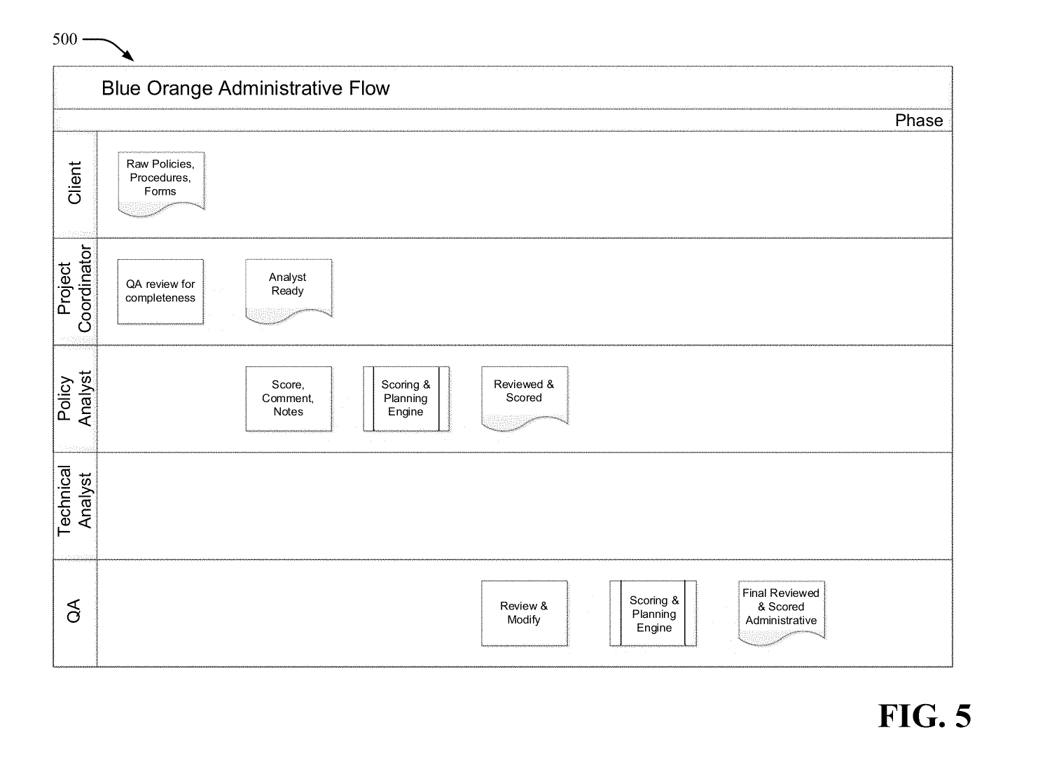

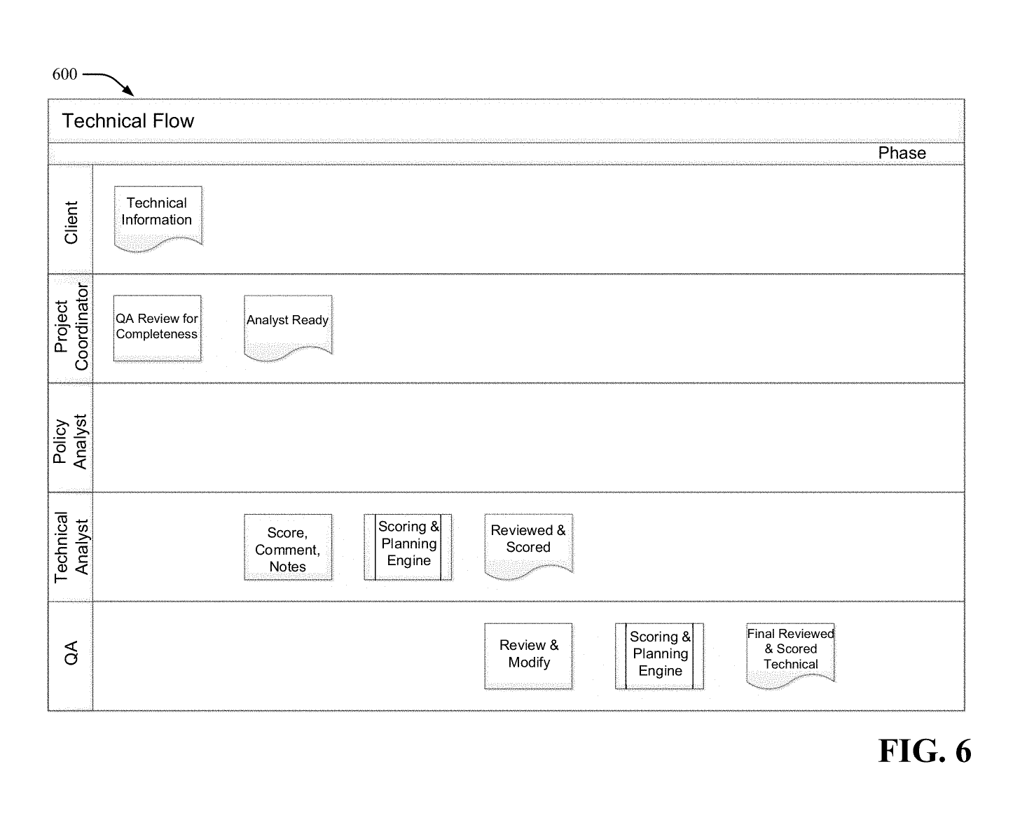

A diagram showing further details of the inputs for the client compliance database 106 is shown in FIG. 4. The diagram illustrates the four categories of client input data included in the client compliance data 224 which are covered in the comprehensive evaluation process. These categories include all policies, processes and procedures and technical and environmental structures of the client, including Covered Entities and their Business Associates who have access to protected health information of the Covered Entity. The four categories include the following items employed in a continuous and recurring progression: administrative, technical, physical and process flow. Administrative flow is data relating to policies, procedures, contracts, and training. Technical flow is data relating to technical environment, vulnerability scans, technology tools, and configuration information. Physical flow is data relating to physical controls including location of screens, monitors, and access to secure areas. Process flow is data relating to the description of current processes surrounding the collection, storage and transmission of Electronic Protected Health Information (EPHI). A flow diagram showing further details of the method and system 200 for managing compliance plans is shown in FIG. 5. The flow diagram further details the evaluation Covered Entity. This physical category of client compliance data 224 is reviewed and scored (e.g., using scoring component 130) similarly to the data for FIGS. 5 and 6 above.

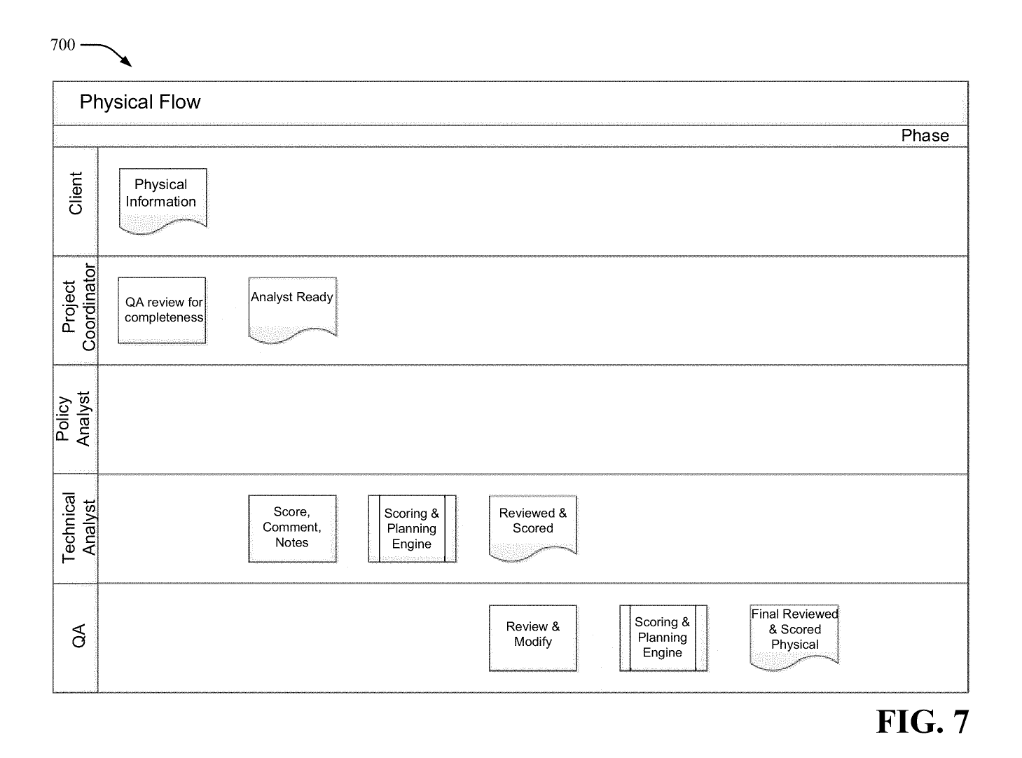

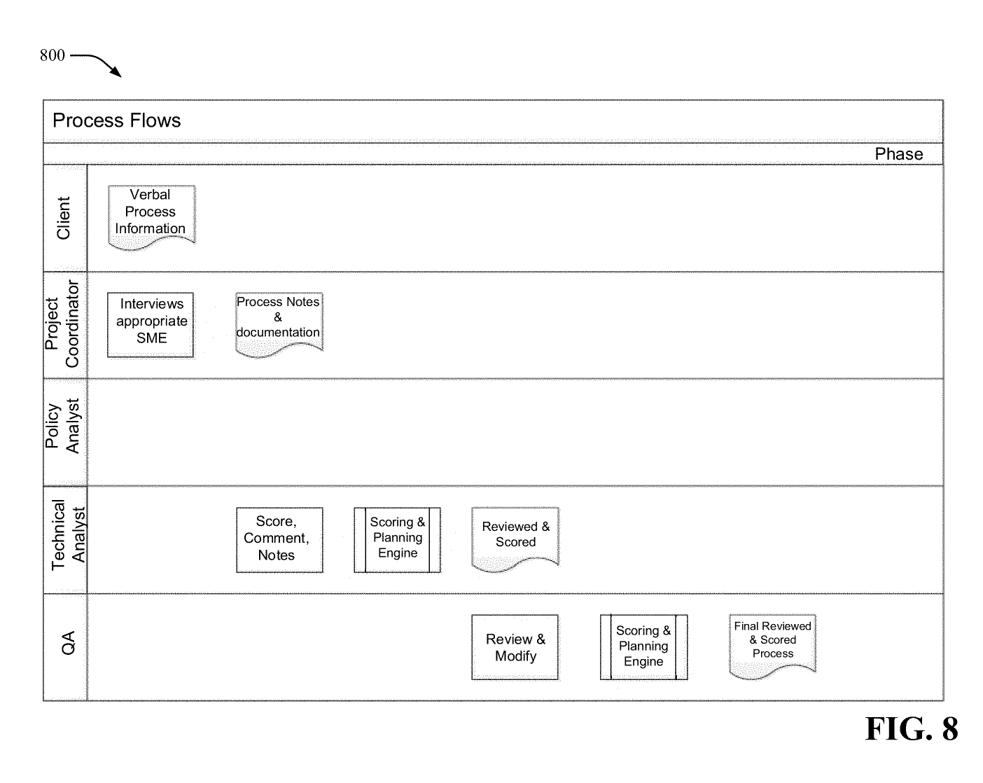

A flow diagram showing further details of the method and system 200 for managing compliance plans is shown in FIG. 8. The flow diagram further details the evaluation processing of the process client data flow category shown in FIG. 4. This category includes current processes surrounding the collection, storage and transmission of Electronic Protected Health Information (EPHI) of Covered Entities and their Business Associates who have access to protected health information of the Covered Entity. This process category of client compliance data 224 is reviewed and scored (e.g., using scoring component 130) similarly to the data for FIGS. 5, 6 and 7 above.

A flow diagram showing further details of the method and system 200 for managing compliance plans is shown in FIG. 9. The flow diagram indicates the client compliance data input categories for client compliance database 106 that is in communication with the provider processor 102. The flow diagram further details the compliance related outputs of provider processor 102 based on the performance of the scoring and planning engine 103 (e.g., utilizing scoring component 130 or first planning component 120). As shown in the previous figures, the client compliance data 224 input categories include administrative, technical, physical and process flow information. As noted above, provider 114 utilizes these four categories of client compliance data 224 to perform initial raw scoring (e.g., using scoring component 130) of the client compliance data and inputs it to form the client compliance database 106.

The flow diagram also details the outputs available from provider processor 102 generated as part of the client compliance remediation plan 110. The client compliance remediation plan 110 may include an assessment snapshot, risk profile and peer report, regulation scores, control scores, a prioritized remediation plan and a timeline schedule. The prioritized remediation plan generated may be based on risk, impact, cost, feasibility and resources. The assessment snapshot is a word document generated by the provider processor 102. Provider 114 may provide both an electronic and a hardcopy format of the assessment snapshot to client 112, with the electronic copy available through the client portal 222. The assessment snapshot furnishes a detailed analysis and summary of the security or compliance assessment provided by provider 114. Components of the assessment snapshot may include an Executive Summary, Environment Summary, Observations and Risk Assessment Results, Current Recommendations, Approach and Go Forward Plan, Policies, and a Gap report.

The Executive Summary may include an Overall summary, Current Compliance Summary Status, Covered Facilities, Current Enterprise Findings & Recommendations, Practice Findings and Recommendations, Compliance Dashboard, Summary of Work Performed, and Analysis Methodology. The Environment Summary may include an Environment Profile, Active Directory Security Profile, Single Sign-on Security Profile, and Electronic Health Records Profile.

The Observations and Risk Assessment Results may include a Meaningful Use Status, HIPAA Security Rule Status, Security Controls, Policy and Procedure mapping, Related Technology, Business Associate Management Status, and Contingency Planning and Emergency Operations.

The Current recommendations, Approach and Go Forward Plan may include Current Recommendations, Recommendations Approach, a High Level Plan of Action and Milestone (POAM), and Recommended Compliance Process Going Forward. The Policies may include a list of missing required policies needed by the client to meet current compliance as determined by the provider processor 102.

The Gap Report may include a list of missing required items needed by the client to meet current compliance as determined by the provider processor 102. The Risk Profile and Peer Report may be included as part of the above-mentioned Compliance Dashboard. The Risk Profile is a summary of the client's current security and privacy risks generated by the provider processor 102. The Peer Report is a comparison of the client's security and privacy compliancy with other clients of similar type and size generated by the provider processor 102. The Regulation Scores are the final HIPAA Security Rule scoring generated by the provider processor 102. The Control Scores are the final Security Control scoring generated by the provider processor 102.

The Prioritized Remediation Plan generated by the provider processor 102 may include a list of recommendations for improved security and privacy compliancy, a recommendation approach plan that outlines best-practice remediation steps, and a Plan of Action and Milestone (POAM) Project Gantt Chart. The list of improvement recommendations may be prioritized based on items posing the highest risk of a security or privacy breach. The recommendation approach plan generated by the provider processor 102 may include Policy Adoption, Day-to Day Process Integration, Business Associate Management, Documentation Maintenance & Audit, and Process and Procedure Oversight.

The Timeline Schedule is generated by the provider 114 based on the data output of the provider processor 102. Provider 114 works with Client 112 to identify and assign target completion dates for all items on the prioritized remediation plan. Dates are assigned based on the priority of the remediation item, and on client resource availability. These remediation items and target completion dates are then incorporated into the Client Compliance Remediation Plan 110, which are accessible through client portal 222, and updated as items are remediated.

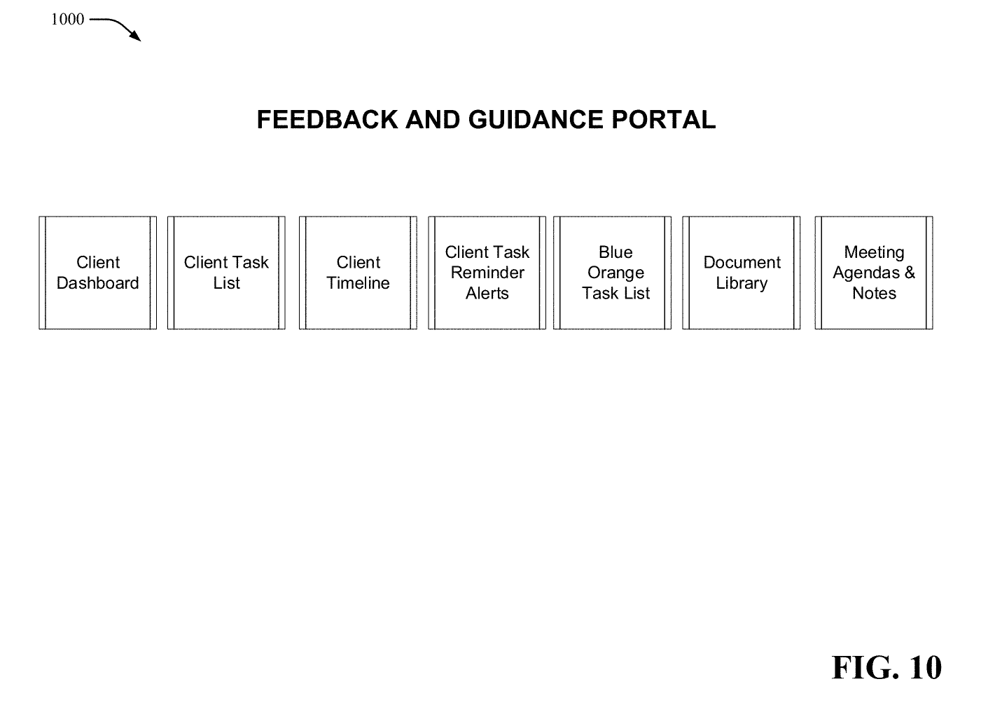

A diagram showing further details of the client portal 222 (also referred to as portal component 222) of FIG. 2 is shown in FIG. 10. The diagram details the items provided by the provider 114 to capture and report progress throughout the continuous and recurring process, while executing and managing a customized compliancy guidance plan, and providing the client 112 with a device to provide feedback. Client portal 222 may include providing access (e.g., using client portal component 222) to a client dashboard, prioritized client task list, client timeline, client task reminder alerts, provider task list, document library and meeting agendas and notes. The client dashboard allows the client to provide real-time compliance status progress feedback on remediation activities. It also provides newsfeed on relevant current events including changes in federal and state statutes, identifies remediation tasks and resources, and manages resources and timelines tied to both client and provider remediation tasks. The document reference library includes both provider-supplied “sample” compliant policies and processes as well as provider-approved and client-deployed policies and processes.

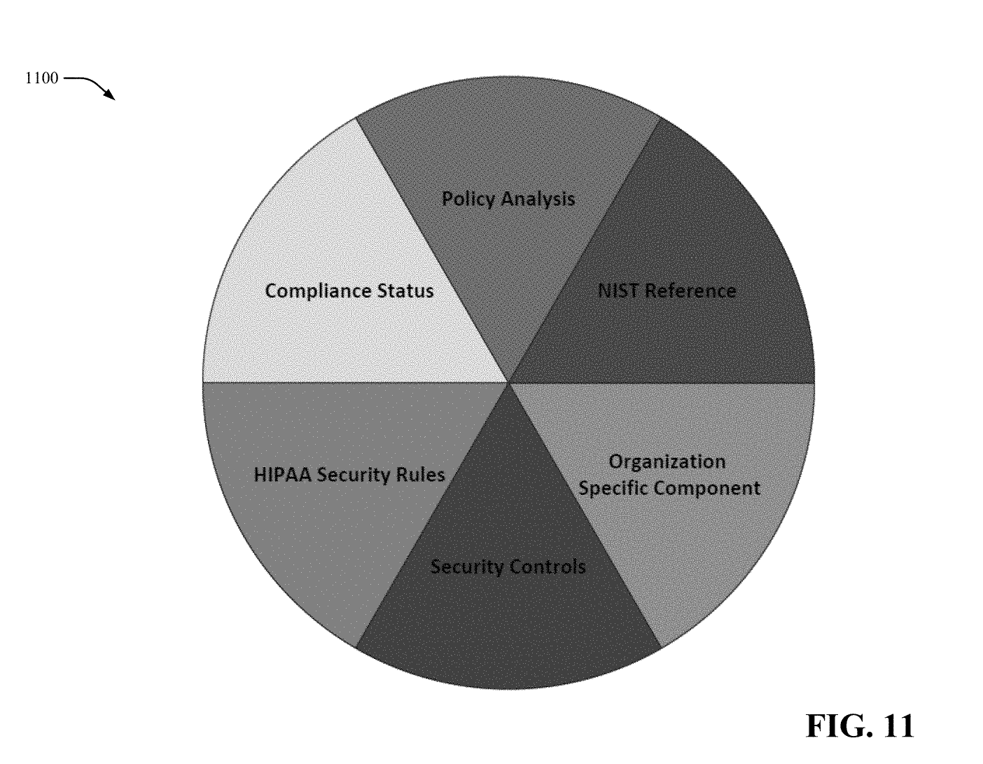

The client portal 222 may further include policy implementation guidance, the most recent vulnerability environmental scans, and may execute and manage a customized compliancy guidance program. The customized compliancy guidance program may be based on client resources, remediation items, remediation progress, recent new technology implementation and plans, newly identified risks and any regulation changes. A diagram showing input and output components of the provider processor 102 of FIG. 2 is shown in FIG. 11. Host compliance database 104 is created and updated with host data relating to governmental compliance requirements, which is accessed by provider processor 102. As a non-limiting example, this host data may include data relating to NIST References, HIPAA Security Rules/Regulations and Security Controls, as detailed below. Client compliance database 106 is created and updated with client data, which is accessed by provider processor 102. As a non-limiting example, this client data may include data relating to organization specific parameters and policy analysis, as detailed below.

In one embodiment, client 112 may provide client compliance data 224 relating to administrative, technical, physical and process flows to provider 114. Provider 114 then performs an initial evaluation and scoring (e.g., using scoring component 130) of client compliance data 224 as it relates to the host compliance database 104 to generate (e.g., using first planning component 120) the client compliance database 106. Provider processor 102 then utilizes scoring and planning engine 103 to perform a final evaluation and scoring of the client compliance database 106 as it relates to the host compliance database 104.

The National Institute of Standards and Technology (NIST) has developed national guidelines to improve the efficiency and effectiveness of information technology planning, implementation, management, and operation. These NIST references serve as a guideline and best practice model for the evaluation of the client compliance database. HIPAA Security Rules are a national set of security standards for protecting health information that is held or transferred in electronic form. The list of HIPAA Security Rules are categorized as follows: Administrative Safeguards, Physical Safeguards, Technical Safeguards, and Organizational Safeguards.

Security Controls are a series of Office for Civil Rights (OCR) recommended processes and procedures fount in NIST Special Publication 800-66 rev 1 that encompass the safeguards or countermeasures used to avoid, counteract or minimize security risks. The list of applicable Security Controls found in NIST 800-53 are categorized as follows: AC Access Control; AT Awareness and Training, AU Audit and Accountability, CA Certification, Accreditation, and Security Assessments, CM Configuration Management, CP Contingency Planning, IA Identification and Authentication, IR Incident Response, MA Maintenance, MP Media Protection, PE Physical and Environmental Protection, PL Planning, PS Personnel Security, RA Risk Assessment, SA System and Services Acquisition, SC System and Communications Protection, SI System and Information Integrity, and PM Program Management.

Using NIST references, provider 114 performs an initial evaluation and scoring of client compliance data 224 as it relates to these HIPAA Security Rules and Security Controls to generate the client compliance database 106. Further, using NIST references, provider 114 performs an initial evaluation and scoring of client compliance data 224 as it relates to client use and implementation of (or absence thereof) governmental Security and Privacy policies to generate the client compliance database 106. This policy use analysis may rely on the following criteria: content thoroughness and relevancy, adoption processes and procedures, implementation method and training, and oversight policy and practices.

An additional component to the initial evaluation and scoring of client compliance is the client's organization specific parameters. Each client organization will have a specific set of risk parameters based on industry, size, geographic location, and other parameters deemed relevant to scoring risk and compliance with regulations. Provider 114 utilizes the client's organization specific parameters of client compliance data 224 when performing the initial evaluation and scoring to generate the client compliance database 106. Provider processor

102 then utilizes scoring and planning engine 103 to perform a final evaluation and scoring of the client compliance database 106 as it relates to the host compliance database 104.

As a first step in the final evaluation and scoring, provider processor 102 generates a customized client compliance plan 108 based on the client's organization specific parameters. Utilizing scoring and planning engine 103, provider processor 102 then uses the NIST references of host compliance database 104 to compare the client compliance plan 108 against HIPAA Security Rules and Security Controls of the host compliance database 104. Provider processor 102 uses the comparison to generate compliancy scores for each of the relevant HIPAA Security Rules and Security Controls. Each compliancy score is then evaluated by provider processor 102 and assigned a rating of“compliant”, “needs improvement” or “non-compliant.” Using the ratings of client compliancy scores, the provider processor 102 then generates a deficiency analysis for each Security Rule and Security Control that was ultimately rated either as “Needs Improvement” or “Non-Compliant” relative to the client compliance plan 108. The deficiency analysis is used by the provider processor 102 to produce a compliance status output or the client compliance remediation plan 110.

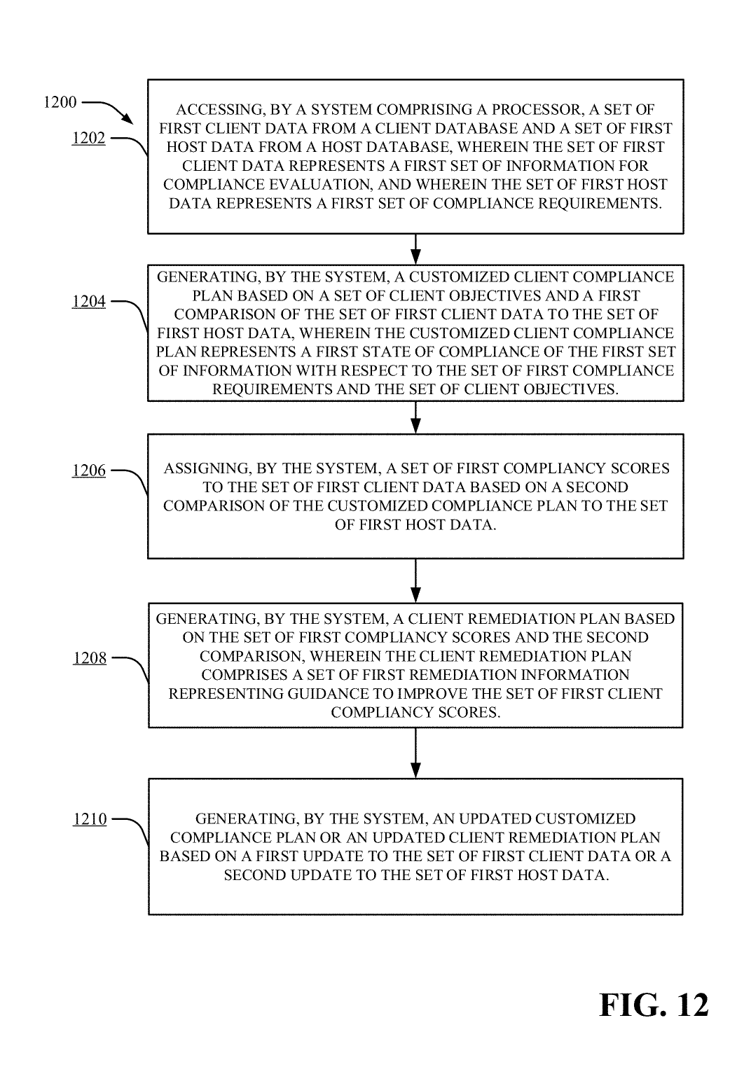

FIGS. 12-15 illustrate various methodologies in accordance with certain embodiments of this disclosure. While, for purposes of simplicity of explanation, the methodologies are shown media a series of acts within the context of various flowcharts, it is to be understood and appreciated that embodiments of the disclosure are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media. It is noted that the methods depicted in FIGS. 12-15 can be performed by various systems disclosed herein, such as systems 100A, 100B, 100C, 100D, 100E, 100F, 100G, and 200-1000.

FIG. 12 provides an example method 1200 for managing compliance plans in accordance with aspects and embodiments described herein. Repetitive description of like elements employed in system and methods disclosed herein is omitted for sake of brevity.

At 1202, a set of first client data from a client database and a set of first host data from a host database is accessed (e.g., using access component 118), wherein the set of first client data represents a first set of information for compliance evaluation, and wherein the set of first host data represents a first set of compliance requirements. At 1204, a customized client compliance plan is generated (e.g., using first planning component 120) based on a set of client objectives and a first comparison of the set of first client data to the set of first host data, wherein the customized client compliance plan represents a first state of compliance of the first set of information with respect to the set of first compliance requirements and the set of client objectives. At 1206, a set of first compliancy scores is assigned (e.g., using scoring component 130) to the set of first client data based on a second comparison of the customized client compliance plan to the set of first host data.

At 1208, a client remediation plan is generated (e.g., using first generation component 140) based on the set of first compliancy scores and the second comparison, wherein the client remediation plan comprises a set of first remediation information representing guidance to improve the set of first client compliancy scores. At 1210, an updated customized client compliance plan is generated (e.g., using second generation component 150) or an updated client remediation plan based on a first update to the set of first client data or a second update to the set of first host data.

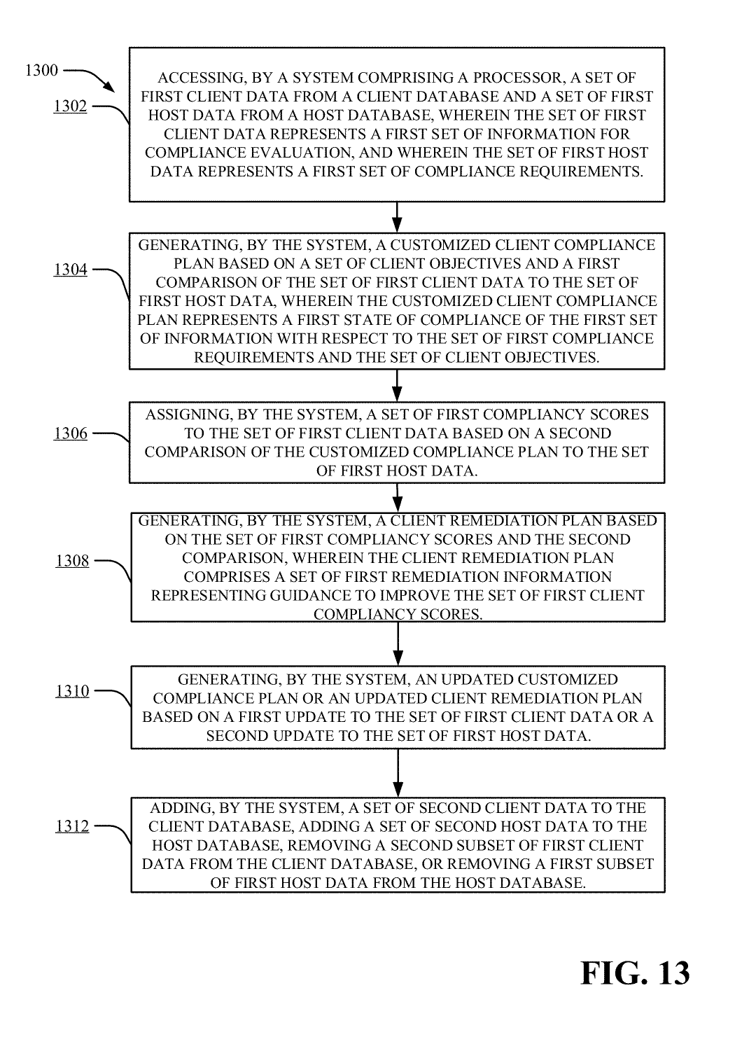

FIG. 13 provides an example method 1300 for managing compliance plans in accordance with aspects and embodiments described herein. Repetitive description of like elements employed in system and methods disclosed herein is omitted for sake of brevity.

At 1302, a set of first client data from a client database and a set of first host data from a host database is accessed (e.g., using access component 118), wherein the set of first client data represents a first set of information for compliance evaluation, and wherein the set of first host data represents a first set of compliance requirements. At 1304, a customized client compliance plan is generated (e.g., using first planning component 120) based on a set of client objectives and a first comparison of the set of first client data to the set of first host data, wherein the customized client compliance plan represents a first state of compliance of the first set of information with respect to the set of first compliance requirements and the set of client objectives. At 1306, a set of first compliancy scores is assigned (e.g., using scoring component 130) to the set of first client data based on a second comparison of the customized client compliance plan to the set of first host data.

At 1308, a client remediation plan is generated (e.g., using first generation component 140) based on the set of first compliancy scores and the second comparison, wherein the client remediation plan comprises a set of first remediation information representing guidance to improve the set of first client compliancy scores. At 1310, an updated customized client compliance plan is generated (e.g., using second generation component 150) or an updated client remediation plan based on a first update to the set of first client data or a second update to the set of first host data. At 1312, a set of second client data is added (e.g., using update component 180) to the client database, a set of second host data is added to the host database, a second subset of first client data is removed from the client database, or a first subset of first host data is removed from the host database.

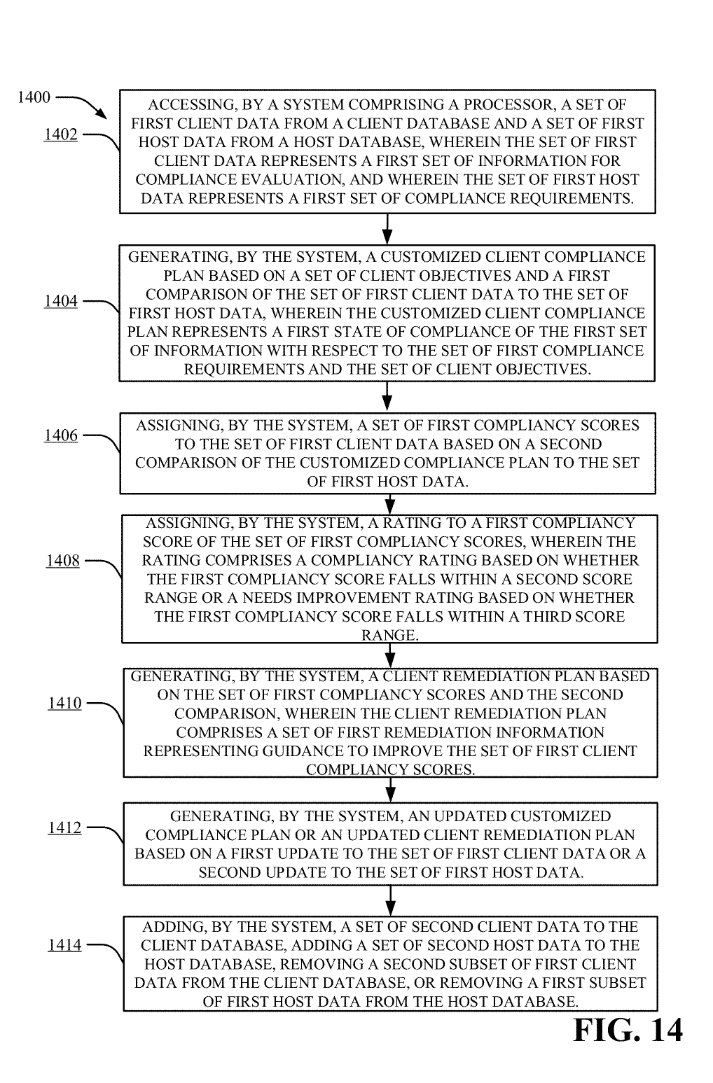

FIG. 14 provides an example method 1400 for managing compliance plans in accordance with aspects and embodiments described herein. Repetitive description of like elements employed in system and methods disclosed herein is omitted for sake of brevity.

At 1402, a set of first client data from a client database and a set of first host data from a host database is accessed (e.g., using access component 118), wherein the set of first client data represents a first set of information for compliance evaluation, and wherein the set of first host data represents a first set of compliance requirements. At 1404, a customized client compliance plan is generated (e.g., using first planning component 120) based on a set of client objectives and a first comparison of the set of first client data to the set of first host data, wherein the customized client compliance plan represents a first state of compliance of the first set of information with respect to the set of first compliance requirements and the set of client objectives. At 1406, a set of first compliancy scores is assigned (e.g., using scoring component 130) to the set of first client data based on a second comparison of the customized client compliance plan to the set of first host data. At 1408, a rating (e.g., using rating component 190) is assigned to a first compliancy score of the set of first compliancy scores, wherein the rating comprises a compliancy rating based on whether the first compliancy score falls within a second score range, or a needs improvement rating based on whether the first compliancy score falls within a third score range.

At 1410, a client remediation plan is generated (e.g., using first generation component 140) based on the set of first compliancy scores and the second comparison, wherein the client remediation plan comprises a set of first remediation information representing guidance to improve the set of first client compliancy scores. At 1412, an updated customized client compliance plan is generated (e.g., using second generation component 150) or an updated client remediation plan based on a first update to the set of first client data or a second update to the set of first host data. At 1414, a set of second client data is added (e.g., using update component 180) to the client database, a set of second host data is added to the host database, a second subset of first client data is removed from the client database, or a first subset of first host data is removed from the host database.

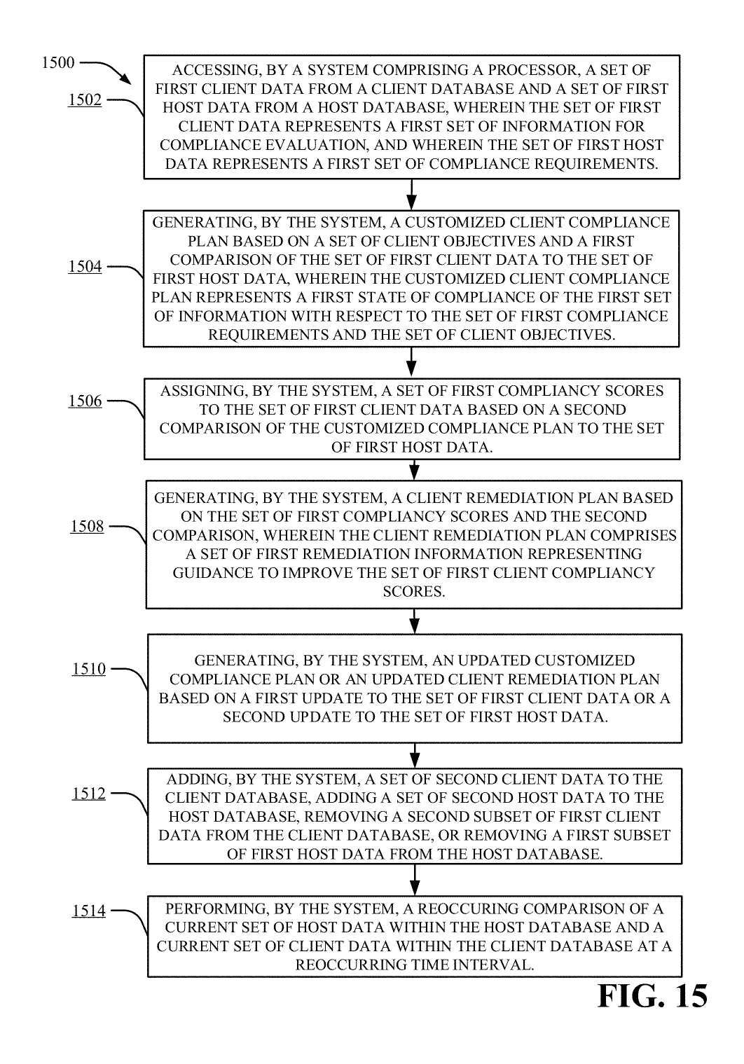

FIG. 15 provides an example method 1500 for managing compliance plans in accordance with aspects and embodiments described herein. Repetitive description of like elements employed in system and methods disclosed herein is omitted for sake of brevity.

At 1502, a set of first client data from a client database and a set of first host data from a host database is accessed (e.g., using access component 118), wherein the set of first client data represents a first set of information for compliance evaluation, and wherein the set of first host data represents a first set of compliance requirements. At 1504, a customized client compliance plan is generated (e.g., using first planning component 120) based on a set of client objectives and a first comparison of the set of first client data to the set of first host data, wherein the customized client compliance plan represents a first state of compliance of the first set of information with respect to the set of first compliance requirements and the set of client objectives. At 1506, a set of first compliancy scores is assigned (e.g., using scoring component 130) to the set of first client data based on a second comparison of the customized client compliance plan to the set of first host data.

At 1508, a client remediation plan is generated (e.g., using first generation component 140) based on the set of first compliancy scores and the second comparison, wherein the client remediation plan comprises a set of first remediation information representing guidance to improve the set of first client compliancy scores. At 1510, an updated customized client compliance plan or an updated client remediation plan is generated (e.g., using second generation component 150) based on a first update to the set of first client data or a second update to the set of first host data. At 1512, a set of second client data is added (e.g., using update component 180) to the client database, a set of second host data is added to the host database, a second subset of first client data is removed from the client database, or a first subset of first host data is removed from the host database. At 1514, a reoccurring comparison of a current set of host data within the host database and a current set of client data within the client database is performed (e.g., using reevaluation component 192) at a reoccurring time interval.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

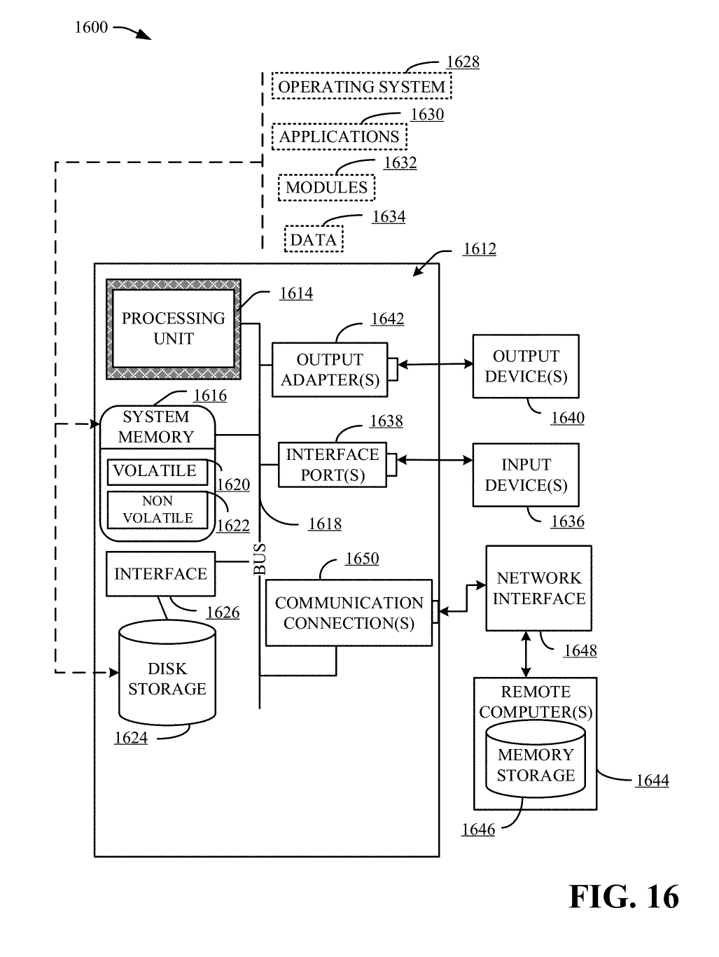

With reference to FIG. 16, a suitable environment 1600 for implementing various aspects of the claimed subject matter includes a computer 1602. The computer 1602 includes a processing unit 1604, a system memory 1606, a codec 1605, and a system bus 1608. The system bus 1608 couples system components including, but not limited to, the system memory 1606 to the processing unit 1604. The processing unit 1604 can be any of various available suitable processors. Dual microprocessors and other multiprocessor architectures also can be employed as the processing unit 1604.

The system bus 1608 can be any of several types of suitable bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 16104), and Small Computer Systems Interface (SCSI).

The system memory 1606 includes volatile memory 1610 and non-volatile memory 1612. The basic input/output system (BIOS), containing the basic routines to transfer information between elements within the computer 1602, such as during start-up, is stored in non-volatile memory 1612. In addition, according to present innovations, codec 1605 may include at least one of an encoder or decoder, wherein the at least one of an encoder or decoder may consist of hardware, a combination of hardware and software, or software. Although, codec 1605 is depicted as a separate component, codec 1605 may be contained within non-volatile memory 1612. By way of illustration, and not limitation, non-volatile memory 1612 can include read only memory (ROM), programmable ROM (PROM), electrically programmable ROM (EPROM), electrically erasable programmable ROM (EEPROM), or flash memory. Volatile memory 1610 includes random access memory (RAM), which acts as external cache memory. According to present aspects, the volatile memory may store the write operation retry logic (not shown in FIG. 16) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDIRAM.

Computer 1602 may also include removable/non-removable, volatile/non-volatile computer storage medium. FIG. 16 illustrates, for example, disk storage 1614. Disk storage 1614 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1614 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1614 to the system bus 1608, a removable or non-removable interface is typically used, such as interface 1616.

It is to be appreciated that FIG. 16 describes software that acts as an intermediary between users and the basic computer resources described in the suitable operating environment 1600. Such software includes an operating system 1618. Operating system 1618, which can be stored on disk storage 1614, acts to control and allocate resources of the computer system 1602. Applications 1620 take advantage of the management of resources by operating system 1618 through program modules 1624, and program data 1626, such as the boot/shutdown transaction table and the like, stored either in system memory 1606 or on disk storage 1614. It is to be appreciated that the claimed subject matter can be implemented with various operating systems or combinations of operating systems.

A user enters commands or information into the computer 1602 through input device(s) 1628. Input devices 1628 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1604 through the system bus 1608 via interface port(s) 1630. Interface port(s) 1630 include, for example, a serial port, a parallel port, a game port, and a universal serial bus (USB). Output device(s) 1636 use some of the same type of ports as input device(s). Thus, for example, a USB port may be used to provide input to computer 1602, and to output information from computer 1602 to an output device 1636. Output adapter 1634 is provided to illustrate that there are some output devices 1636 like monitors, speakers, and printers, among other output devices 1636, which require special adapters. The output adapters 1634 include, by way of illustration and not limitation, video and sound cards that provide a means of connection between the output device 1636 and the system bus 1608. It should be noted that other devices and/or systems of devices provide both input and output capabilities such as remote computer(s) 1638.

Computer 1602 can operate in a networked environment using logical connections to one or more remote computers, such as remote computer(s) 1638. The remote computer(s) 1638 can be a personal computer, a server, a router, a network PC, a workstation, a microprocessor based appliance, a peer device, a smart phone, a tablet, or other network node, and typically includes many of the elements described relative to computer 1602. For purposes of brevity, only a memory storage device 1640 is illustrated with remote computer(s) 1638. Remote computer(s) 1638 is logically connected to computer 1602 through a network interface 1642 and then connected via communication connection(s) 1644. Network interface 1642 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1644 refers to the hardware/software employed to connect the network interface 1642 to the bus 1608. While communication connection 1644 is shown for illustrative clarity inside computer 1602, it can also be external to computer 1602. The hardware/software necessary for connection to the network interface 1642 includes, for exemplary purposes only, internal and external technologies such as, modems including regular telephone grade modems, cable modems and DSL modems, ISDN adapters, and wired and wireless Ethernet cards, hubs, and routers.

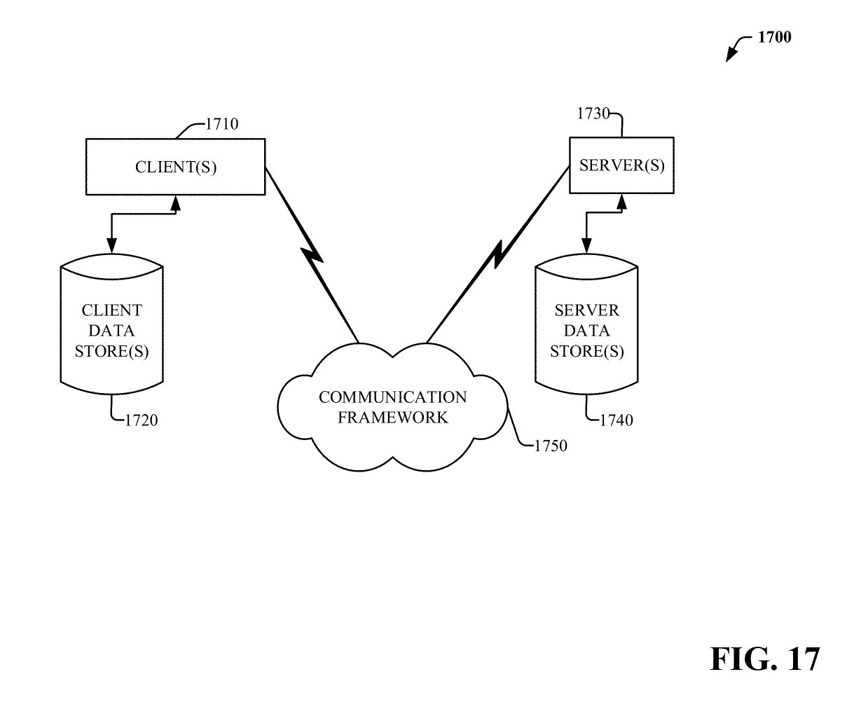

Referring now to FIG. 17, there is illustrated a schematic block diagram of a computing environment 1700 in accordance with this disclosure. The system 1700 includes one or more client(s) 1702 (e.g., laptops, smart phones, PDAs, media players, computers, portable electronic devices, tablets, and the like). The client(s) 1702 can be hardware and/or software (e.g., threads, processes, computing devices). The system 1700 also includes one or more server(s) 1704. The server(s) 1704 can also be hardware or hardware in combination with software (e.g., threads, processes, computing devices). The servers 1704 can house threads to perform transformations by employing aspects of this disclosure, for example. One possible communication between a client 1702 and a server 1704 can be in the form of a data packet transmitted between two or more computer processes wherein the data packet may include video data. The data packet can include a metadata, e.g., associated contextual information, for example. The system 1700 includes a communication framework 1706 (e.g., a global communication network such as the Internet, or mobile network(s)) that can be employed to facilitate communications between the client(s) 1702 and the server(s) 1704.

Communications can be facilitated via a wired (including optical fiber) and/or wireless technology. The client(s) 1702 include or are operatively connected to one or more client data store(s) 1708 that can be employed to store information local to the client(s) 1702 (e.g., associated contextual information). Similarly, the server(s) 1704 are operatively include or are operatively connected to one or more server data store(s) 1710 that can be employed to store information local to the servers 1704.

In one embodiment, a client 1702 can transfer an encoded file, in accordance with the disclosed subject matter, to server 1704. Server 1704 can store the file, decode the file, or transmit the file to another client 1702. It is to be appreciated, that a client 1702 can also transfer uncompressed file to a server 1704 and server 1704 can compress the file in accordance with the disclosed subject matter. Likewise, server 1704 can encode video information and transmit the information via communication framework 1706 to one or more clients 1702.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A, X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from a computer-readable device or storage media.

What is claimed is:

1. A system, comprising:
a memory that stores executable components; and
a processor, communicatively coupled to the memory, the processor configured to facilitate execution of the executable components, the executable components comprising:
an access component configured to access a set of first client data from a client database and a set of first host data from a host database, wherein the set of first client data represents a first set of information for compliance evaluation, and wherein the set of first host data represents a first set of compliance requirements;
a first planning component configured to generate a customized client compliance plan based on a set of client objectives and a first comparison of the set of first client data to the set of first host data, wherein the customized client compliance plan represents a first state of compliance of the first set of information with respect to the set of first compliance requirements and the set of client objectives;
a scoring component configured to assign a set of first compliancy scores to the set of first client data based on a second comparison of the customized client compliance plan to the set of first host data;
a first generation component configured to generate a client remediation plan based on the set of first compliancy scores and the second comparison, wherein the client remediation plan comprises a set of first remediation information representing guidance to improve the set of first client compliancy scores; and
a second generation component configured to generate an updated customized client compliance plan or an updated client remediation plan based on a first update to the set of first client data or a second update to the set of first host data.

2. The system of claim 1, wherein a first subset of first client data of the set of first client data represents client compliance items required to satisfy a set of first compliance criteria and a second subset of first client data of the set of first client data represent a set of organization specific parameters.

3. The system of claim 1, wherein the first set of host data comprises federal regulatory requirement data, state regulatory requirement data, best practice compliance data, industry focused requirement data, control rule data, privacy compliance requirement data, or security compliance regulatory data comprising any one or more of International Organization for Standardization requirement data, Payment Card Industry requirement data, or Joint Commission on Accreditation of Healthcare Organizations requirement data.

4. The system of claim 1, further comprising an update component that adds a set of second client data to the client database, adds a set of second host data to the host database, removes a second subset of first client data from the client database, or removes a first subset of first host data from the host database,
wherein an addition of the set of second client data or a removal of a second subset of client data is based on the first update, the updated customized client compliance plan, the updated client remediation plan, a satisfaction of the first set of compliance requirements, a creation of new client goals or new client objectives in accordance with the set of second host data, and
wherein an addition of the set of second host data or a removal of the first subset of first host data is based on the second update to the set of first host data, the updated customized client compliance plan, the updated client remediation plan, an update to healthcare laws, an update to healthcare regulations, an update to privacy compliancy rules, an update to security compliancy rules.

5. The system of claim 1, further comprising a rating component that assigns a rating to a first compliancy score of the set of first compliancy scores, wherein the rating comprises a compliant rating based on whether the the first compliancy score falls within a first score range, a non-compliant rating based on whether the first compliancy score falls within a second score range, a needs improvement rating based on whether the first compliancy score falls within a third score range, a capability maturity rating that represents a client's compliance maturity based on whether the first compliancy score falls within a fourth score range in accordance with a capability maturity model, a cyber security rating based on whether the first compliancy score falls within a fifth score range in accordance with a cyber security framework.

6. The system of claim 5, wherein the set of first remediation information comprises a list of required items to achieve the compliant rating, wherein an item of the list of items corresponds to a priority level.

7. The system of claim 1, further comprising a reevaluation component that performs a reoccurring comparison of a current set of host data within the host database and a current set of client data within the client database at a reoccurring time interval.

8. The system of claim 4, wherein the set of second host data comprises updated federal regulatory requirement data, updated state regulatory requirement data, updated best practice compliance data, or updated industry focused requirement data, and wherein the set of second client data comprises new client data previously absent from the set of first client data for compliance evaluation or a rescored subset of first client data of the set of first client data based on a client implementation activity associated with the client remediation plan.

9. The system of claim 1, further comprising a presentation component that facilitates access by a provider device or a client device to an assessment output associated with the first state of compliance, wherein the assessment output comprises at least one of a snapshot summary of the first state of compliance, an online active plan, an online active assessment corresponding to the client compliance plan, a risk profile corresponding to the first state of compliance, a peer report, a set of regulation scores associated with the set of first client data, a set of control scores associated with the set of first client data, the client compliance remediation plan, a timeline schedule associated with the client compliance remediation plan, a gap report comprising missing compliance items, a current recommendation report, an observation and risk assessment result report, an executive summary, or an environment study.

10. The system of claim 1, wherein the set of first client data comprise policy data, process flow data, procedural data, technical flow data, environmental structure data, administrative flow data, technical flow data, physical flow data, process flow of data or organizational data, and wherein a first compliance score, a second compliance score, a third compliance score, and a fourth compliance score of the set of compliancy scores correspond to the administrative flow, the technical flow, the physical flow data, and the process flow data respectively.

11. The system of claim 1, further comprising a portal component that facilitates management of the client remediation plan and facilitates an interactive analysis of client data at an interface corresponding to a client device, wherein the interface comprises a client dashboard, a prioritized client task list, a client timeline, a client task reminder alert, a provider task list, a document library, or a meeting agenda and note application, and wherein the interface presents continuous correspondence of a subsequent state of compliance as compared to the first state of compliance, an analysis component that facilitates an application of analytics to client data or host data, or a recommendation component that provides a recommendation based on analyzed client data.

12. The system of claim 1, wherein the first state of compliance comprises a set of deficient compliant items or a set of missing compliance items that fail to satisfy the first set of compliance requirements.

13. A method comprising,
accessing, by a system comprising a processor, a set of first client data from a client database and a set of first host data from a host database, wherein the set of first client data represents a first set of information for compliance evaluation, and wherein the set of first host data represents a first set of compliance requirements;
generating, by the system, a customized client compliance plan based on a set of client objectives and a first comparison of the set of first client data to the set of first host data, wherein the customized client compliance plan represents a first state of compliance of the first set of information with respect to the set of first compliance requirements and the set of client objectives;
assigning, by the system, a set of first compliancy scores to the set of first client data based on a second comparison of the customized client compliance plan to the set of first host data;
generating, by the system, a client remediation plan based on the set of first compliancy scores and the second comparison, wherein the client remediation plan comprises a set of first remediation information representing guidance to improve the set of first client compliancy scores; and
generating, by the system, an updated customized client compliance plan or an updated client remediation plan based on a first update to the set of first client data or a second update to the set of first host data.

14. The method of claim 13, further comprising adding, by the system, a set of second client data to the client database, adding a set of second host data to the host database, removing a second subset of first client data from the client database, or removing a first subset of first host data from the host database.

15. The method of claim 13, further comprising assigning, by the system, a rating to a first compliancy score of the set of first compliancy scores, wherein the rating comprises a compliancy rating based on whether the first compliancy score falls within a first score range, a non-compliancy rating based on whether the first compliancy score falls within a second score range, or a needs improvement rating based on whether the first compliancy score falls within a third score range.

16. The method of claim 13, further comprising performing, by the system, a reoccurring comparison of a current set of host data within the host database and a current set of client data within the client database at a reoccurring time interval.

17. A method comprising,
receiving, by a system comprising a processor, a first set of client compliance data from a client database
assigning a set of first scores, by the system, to the set of first client compliance data based on a first evaluation of the first set of client compliance data with respect to a first set of host compliance data;
creating a client compliance database comprising a first scored set of first client compliance data based on the set of first scores; and
assigning a set of second scores to the first scored set of first client compliance data based on a comparison of the scored set of first client compliance data to the first set of host compliance data.

18. The method of claim 17, further comprising generating, by the system, a client compliance plan based on a second scored set of first client compliance data, wherein the client compliance plan represents a first state of compliance of the first subset of first client compliance data.

19. The method of claim 17, wherein a first subset of first client compliance data of the set of first compliance data represents administrative flow information, technical flow information, physical flow information, or process flow information.

20. The method of claim 17, further comprising generating, by the system, a client compliance remediation plan comprising a set of outputs, wherein a first output of the set of outputs represents a first state of compliance corresponding to administrative flow information, a second state of compliance corresponding to technical flow information, a third state of compliance corresponding to physical flow information, or a fourth state of compliance corresponding to process flow information.
